(19) United States
(12) Patent Application Publication
(10) Pub. No.: US 2017/0018203 A1
(43) Pub. Date: Jan. 19, 2017

(54) SYSTEMS AND METHODS FOR TEACHING PRONUNCIATION AND/OR READING

(71) Applicant: Learning Circle Kids LLC, Camas, WA (US)

(72) Inventor: Sherrilyn Fisher, Camas, WA (US)

(21) Appl. No.: 15/210,769

(22) Filed: Jul. 14, 2016

Related U.S. Application Data
(60) Provisional application No. 62/192,557, filed on Jul. 14, 2015.

(51) Int. Cl. G09B 19/04; G06T 13/80; G09B 5/12; G06F 3/0484

(52) U.S. Cl. CPC G09B 19/04; G06F 3/04842; G06T 13/80; G09B 5/125; G06T 2200/24

(57) ABSTRACT

Systems and methods for teaching pronunciation are described. One such exemplar method includes: (i) causing to be displayed or displaying at a client device a visual representation of at least one selectable word and an illustration of an object associated with the selectable word; (ii) receiving an instruction that the selectable word is selected by a user; and (iii) causing to be generated or generating at the client device, in response to a selection by the user, an animated sequence that includes providing: (a) at a first location proximate to the illustration of the object, a character representation of each letter present in selectable word; (ii) an audible representation of each letter present in the selectable word; and (iii) at a second location proximate to the illustration of the object, a visual representation of the selectable word and a pronunciation of the selectable word.

### RELATED CASE

This application claims priority to U.S. provisional application No. 62/192,557, filed Jul. 14, 2015, which is incorporated herein by reference for all purposes.

### FIELD

The systems and methods of the present arrangements and teachings generally relate to using an electronic device, such as a tablet computer, a smartphone, a laptop computer, or a desktop computer, to teach a user pronunciation and reading. More particularly, they relate to systems and methods of using an electronic device to teach pronunciation and reading in the context of an animated story that uses character representations of letters that engage with the user in an entertaining manner.

### BACKGROUND

Relatively younger children have difficulty learning pronunciation and reading, as conventional techniques tend to present, to the child, language lessons that do not maintain a child's interest or attention long enough to facilitate the child's progress through the language lessons. What is therefore needed are systems and methods that facilitate providing language lessons to children in an effective and engaging manner.

### SUMMARY OF THE INVENTION

To this end, the present teachings and arrangements provide methods and systems that are used to teach a user, preferably a child, how to pronounce and/or read words.

In one aspect, the present teachings disclose a method for teaching pronunciation. This method for teaching pronunciation includes: (i) causing to be displayed or displaying at a client device a visual representation of at least one selectable word and an illustration of an object associated with the selectable word, wherein the selectable word includes one or more letters; (ii) receiving an instruction that the selectable word is selected by a user; and (iii) causing to be generated or generating at the client device, in response to the selection by the user, an animated sequence that includes providing: (a) at a first location proximate to the illustration of the object, a character representation of each letter present in the selectable word; (b) an audible representation of each letter present in the selectable word; and (c) at a second location proximate to the illustration of the object, a visual representation of the selectable word and a pronunciation of the selectable word. The first location and the second location may be the same. The audible representation of each letter may include a pronunciation of a name of each letter and/or a phonetic pronunciation of a sound associated with each letter. The step of receiving may be carried out using a server and/or the client device.

In preferred embodiments of the present teachings, the visual representation of the selectable word and the illustration of the object associated with the selectable word are part of an illustration of a story and/or a scene. Further, each of the character representations may embody a unique depiction of each letter present in the selectable word and the character representation includes one or more anthropomorphic features. The audible representation of each letter and/or the pronunciation of the selectable word may be accompanied by a depiction of the character representations in a modified state. This modified state may include at least one state chosen from a group comprising shaking, shrinking, expanding, condensing, enlarging, turning, changing color, speaking, looking, and moving.

In certain embodiments of the present teachings, this method of teaching pronunciation further includes causing to be displayed or displaying, at the client device, an indication that the selectable word is selected, wherein the indication includes an animation that depicts an illustration of a human hand tapping on the selectable word, and wherein causing to be displayed or displaying this indication is carried out after the causing to be displayed or displaying of the visual representation of the selectable word.

In another aspect, the present teachings disclose another method for teaching pronunciation. This method for teaching pronunciation includes: (i) causing to be displayed or displaying at a client device a visual representation of at least one selectable word and an illustration of an object associated with the selectable word, and wherein the selectable word includes one or more letters; (ii) receiving an instruction that the selectable word has been selected by a user; and (iii) causing to be generated or generating at the client device, in response to the selection by the user, an animated sequence. The animated sequence provides: (a) one or more character representations for at least some letters present in the selectable word; (b) an audible and/or a visual representation associated with each character representation; and (c) a pronunciation of the selectable word. This method may further include causing to be generated or generating at the client device, in response to the selection of the user, another animated sequence. This animated sequence provides a visual representation of: a selectable word and the object associated with the selectable word. This method may further include pronouncing the selectable word. Preferably, the above-mentioned causing to be generated or generating another animated sequence and pronouncing are carried out after receiving and before causing to be generated or generating the animated sequence described in (iii).

In one preferred embodiment of the present teachings, causing to be generated or generating the animated sequence includes presenting, at the client device, a grid that includes one or more rows and one or more columns and an intersection of one of the rows with one of the column defines a cell. Each cell may be configured to receive the selectable word or the illustration of an object associated with the selectable word. For example, the visual representation of the selectable word is arranged inside a first cell and the visual representation of the object associated with the selectable word is arranged inside the second cell. In this configuration, the first cell and the second cell may be aligned along one of the rows or along one of the columns. Further, the causing to be generated or generating another animated sequence may include causing to be generated or generating the character representation for each letter present in the selectable word in a third cell. This cell may be aligned with the first cell along one of the rows or along one of the columns. Further still, causing to be generated or generating another animated sequence may include causing to be generated or generating a sentence associated with the selectable word in a fourth cell. This cell may be aligned with the first cell along one of the rows or along one of the columns. Further still, causing to be generated or generating another animated sequence may include causing to be generated or generating an illustration associated with or depicting the subject matter described in the sentence in a fifth cell. This cell may be aligned with the second cell along one of the rows or along one of the columns.

In one preferred embodiment of the present teachings, in the above-mentioned step of causing to be generated or generating the animated sequence, the audible and/or visual representation associated with each character representation further includes: (i) depicting each of the character representations being spread out from each other by a certain distance; (ii) providing a phonetic pronunciation for each letter associated with the character representation, as the character representations remain spread out by the certain distance; (iii) depicting each of the character representations as no longer being spread out by the certain distance; and (iv) pronouncing the selectable word.

In the above-mentioned step of causing to be generated or generating the animated sequence, the audible representation of each letter and/or pronunciation of the selectable word may be accompanied by a visual representation that includes depiction of the character representation in a modified state. By way of example, the modified state at least one state chosen from a group comprising shaking, shrinking, expanding, condensing, enlarging, turning, changing color, speaking, turning, and moving.

In yet another aspect, the present teachings disclose another method for teaching pronunciation. This method of teaching pronunciation includes: (i) causing to be displayed or displaying at a client device a visual representation of at least one selectable word and/or an illustration of an object associated with the selectable word, and wherein the selectable word includes one or more letters; (ii) receiving an instruction that the selectable word has been selected by a user; and (iii) causing to be generated or generating at the client device, in response to the selection of the user, an animated sequence. This animated sequence includes providing: (a) a character representation of at least some letters of the selectable word and/or a textual representation of at least some other letters of the selectable word, wherein a combination of the character representation of some letters and/or the textual representation of some other letters conveys the selectable word; (b) the character representation of some letters exhibit anthropomorphic behavior or a changing state of the character representation teaches a pronunciation rule; and (c) a pronunciation of the selectable word. Teaching a pronunciation rule may include at least one technique chosen from a group comprising: (i) teaching pronunciation of a combination of letters that produce a single sound when the selectable word is pronounced; (ii) teaching pronunciation of a selectable word that includes one more silent letters; and (iii) teaching pronunciation of a selectable word that is a sight word.

In certain embodiments of the present teachings, causing to be generated or generating the animated sequence includes presenting, at the client device, a grid that includes one or more rows and one or more columns and an intersection of one of the rows with one of the column defines a cell. The cell may be configured to receive the selectable word or the illustration of an object associated with the selectable word. The visual representation of the selectable word is arranged inside a first cell and the visual representation of the object associated with the selectable word is arranged inside the second cell. In one configuration, the first cell and the second cell are aligned along one of the rows or along one of the columns. Further, causing to be generated or generating another animated sequence may also include causing to be generated or generating the character representation for each letter present in the selectable word in a third cell. This cell may be aligned with the first cell or the second cell along one of the rows or along one of the columns.

The audible and/or the visual representation associated with each character representation may include: (i) depicting each of the character representations being spread out from each other by a certain distance; (ii) providing a phonetic pronunciation for each letter associated with character representation, as the character representations remain spread out by the certain distance; (iii) depicting each of the character representations as no longer being spread out by the certain distance; and (iv) pronouncing the selectable word.

In yet another aspect, the present teachings disclose a system for teaching pronunciation. This system for teaching pronunciation includes: (i) a display module that causes to be displayed or displays, at a client device, a visual representation of at least one selectable word and an illustration of an object associated with the selectable word, wherein the selectable word includes one or more letters; (ii) a user input module that receives an instruction that the selectable word is selected by a user; and (iii) an animation module that causes to be generated or generates, at the client device, in response to the selection by the user, an animated sequence that includes providing: (a) at a first location proximate to the illustration of the object, a character representation of each letter present in the selectable word; (b) an audible representation of each letter present in the selectable word; and (c) at a second location proximate to the illustration of the object, a visual representation of the selectable word and a pronunciation of the selectable word. In certain embodiments of the present teachings, the system for teaching pronunciation includes an illustration/animation module. In one embodiment of the present arrangements, at least a part of or all of the above-mentioned modules are on the server and/or client device. In a preferred embodiment of the present arrangements, however, all of the above-mentioned modules are on the client device.

In another aspect, the present teachings disclose a processor-based teaching platform. The processor-based teaching platform includes: (i) a processor for executing code; (ii) memory, coupled to the processor, for storing code to be executed by the processor; (iii) at least one interface, coupled to the processor, operable to provide a communication link from the processor to one or more client devices and that is used for transmitting and/or receiving information; and wherein the processor performs operations of: (a) causing to be displayed or displaying at a client device a visual representation of at least one selectable word and an illustration of an object associated with the selectable word, wherein the selectable word includes one or more letters; (b) receiving an instruction that the selectable word is selected by a user; and (c) causing to be generated or generating at the client device, in response to the selection by the user, an animated sequence that includes providing: (1) at a first location proximate to the illustration of the object, a character representation of each letter present in the selectable word; (2) an audible representation of each letter present in the selectable word; and (3) at a second location proximate to the illustration of the object, a visual representation of the selectable word and a pronunciation of the selectable word. The first location and the second location may be the same. The audible representation of each letter may include a pronunciation of a name of each letter and/or a phonetic pronunciation of a sound associated with each letter.

In yet another aspect, the present teachings disclose another processor-based teaching platform. The processor-based teaching platform includes: (i) a processor for executing code; (ii) memory, coupled to the processor, for storing code to be executed by the processor; (iii) at least one interface, coupled to the processor, operable to provide a communication link from the processor to one or more client devices and that is used for transmitting and/or receiving information; and wherein the processor performs operations of: (a) causing to be displayed or displaying at a client device a visual representation of at least one selectable word and an illustration of an object associated with the selectable word, and wherein the selectable word includes one or more letters; (b) receiving an instruction that the selectable word has been selected by a user; and (c) causing to be generated or generating at the client device, in response to the selection by the user, an animated sequence. The animated sequence provides: (1) one or more character representations for at least some letters present in the selectable word; (2) an audible and/or a visual representation associated with each character representation; and (3) a pronunciation of the selectable word. This method may further include causing to be generated or generating at the client device, in response to the selection of the user, another animated sequence.

In yet another aspect, the present teachings disclose yet another processor-based teaching platform. The processor-based teaching platform includes: (i) a processor for executing code; (ii) memory, coupled to the processor, for storing code to be executed a processor for executing code; (ii) memory, coupled to the processor, for storing code to be executed by the processor; (iii) at least one interface, coupled to the processor, operable to provide a communication link from the processor to one or more client devices and that is used for transmitting and/or receiving information; and wherein the processor performs operations of: (a) causing to be displayed or displaying at a client device a visual representation of at least one selectable word and/or an illustration of an object associated with the selectable word, and wherein the selectable word includes one or more letters; (b) receiving an instruction that the selectable word has been selected by a user; and (c) causing to be generated or generating at the client device, in response to the selection of the user, an animated sequence. This animated sequence includes providing: (1) a character representation of at least some letters of the selectable word and/or a textual representation of at least some other letters of the selectable word, wherein a combination of the character representation of some letters and/or the textual representation of some other letters conveys the selectable word; (2) the character representation of some letters exhibit anthropomorphic behavior or a changing state of the character representation teaches a pronunciation rule; and (3) a pronunciation of the selectable word.

In yet another aspect, the present teachings disclose a teaching platform. The teaching platform includes: (i) means for causing to be displayed or displaying at a client device a visual representation of at least one selectable word and an illustration of an object associated with the selectable word, wherein the selectable word includes one or more letters; (ii) means for receiving an instruction that the selectable word is selected by a user; and (iii) means for causing to be generated or generating at the client device, in response to the selection by the user, an animated sequence that includes a means for providing: (a) at a first location proximate to the illustration of the object, a character representation of each letter present in the selectable word; (b) an audible representation of each letter present in the selectable word; and (c) at a second location proximate to the illustration of the object, a visual representation of the selectable word and a pronunciation of the selectable word.

The construction and method of operation of the invention, however, together with additional objects and advantages thereof, will be best understood from the following descriptions of specific embodiments when read in connection with the accompanying figure.

### BRIEF DESCRIPTION OF THE DRAWINGS

FIG. 1A shows a network platform, according to one embodiment of the present arrangements, and that couples multiple computing machines, e.g., a server and multiple client devices (e.g., a desktop computer and a mobile device) to each other for computing and/or displaying a teaching lesson.

FIG. 1B shows a blocks diagram of internal components of one or more of the server and/or the client devices, according to one embodiment of the present arrangements and that is shown in FIG. 1A.

FIG. 2A shows internal construction blocks of a computing machine, according to another embodiment of the present arrangements, that may be implemented as the server shown in FIG. 1A.

FIG. 2B shows a functional block diagram of the server of FIG. 2A, according to one embodiment of the present arrangements, and that includes a memory space, which in turn includes a server module executable by one or more processors.

FIG. 3A shows a simplified block diagram of an exemplar client device (i.e., mobile device), according to one embodiment of the present arrangements and that is shown in FIG. 1A.

FIG. 3B shows a functional block diagram of the client device, according to one embodiment of the present arrangements, in which a client module resides in memory space of the client device shown in FIG. 1A.

FIG. 4 is flowchart showing certain salient steps of a process 400, according to one embodiment of the present teachings, for teaching pronunciation of a word.

FIGS. 5A-5E are various exemplar screenshots provided by the systems of the present arrangements and showing a computer-generated animated story that uses character representations of letters to teach pronunciation of words.

FIG. 6 is a flowchart showing certain salient steps of a process 600, according to another embodiment of the present teachings, for teaching pronunciation of a word.

FIGS. 7A-7F are various exemplar screenshots provided by the systems of the present arrangements and showing a computer-generated animated story that uses character representation of letters to teach pronunciation of words.

FIG. 8 is a flowchart showing certain salient steps of a process 600, according to one embodiment of the present teachings, for teaching pronunciation and/or pronunciation rules to a user.

FIG. 9 depicts a series of animated sequence clips, according to one embodiment of the present teachings and that are used to teach a user pronunciation rules and/or pronunciation of a selectable word, such as “boat,” that includes a silent letter

FIGS. 10A-10C depict a series of animated sequence clips, according to one embodiment of the present teachings and that are used to teach children pronunciation rules and/or pronunciation of a selectable word, such as “they,” that includes combinations of letters that produce a single sound.

FIGS. 11A-11D depict a series of animated sequence clips, according to one embodiment of the present teachings and that are used to teach children pronunciation rules and/or pronunciation of a selectable word, such as “rose,” that also includes a silent letter.

FIGS. 12A-12D depict a series of animated sequence clips, according to one embodiment of the present teachings and that are used to teach children pronunciation rules and/or pronunciation of a selectable word, such as “couch,” that includes pronunciation of a combination of letters that produce a single sound.

FIGS. 13A-13D depict a series of animated sequence clips, according to one embodiment of the present teachings and that are used to teach pronunciation rules and/or pronunciation of a selectable word, such as “leaf,” that includes yet another silent letter.

### DETAILED DESCRIPTION OF THE PREFERRED EMBODIMENTS

Embodiments of the present arrangements and teachings now may be described more fully hereinafter with reference to the accompanying figures, in which some, but not all, embodiments of the arrangements and teachings are shown. These arrangements and teachings may be embodied in many different forms and should not be construed as limited to the embodiments set forth herein; rather, these embodiments are provided so that this disclosure may satisfy applicable legal requirements.

The present teachings and arrangements disclosed herein are directed to, among other things, systems and methods related to using an electronic device, such as a tablet, smartphone, personal computer, or desktop computer, to provide tutorial instructions for pronunciation and reading of words using teaching lessons. Preferably, the teaching lessons are presented in a context of illustrated or animated stories that use character representations of letters (i.e., depictions of letters as characters with certain anthropomorphic or other unique features) to facilitate teaching children pronunciation and/or reading of words in the context of the illustrated or animated story.

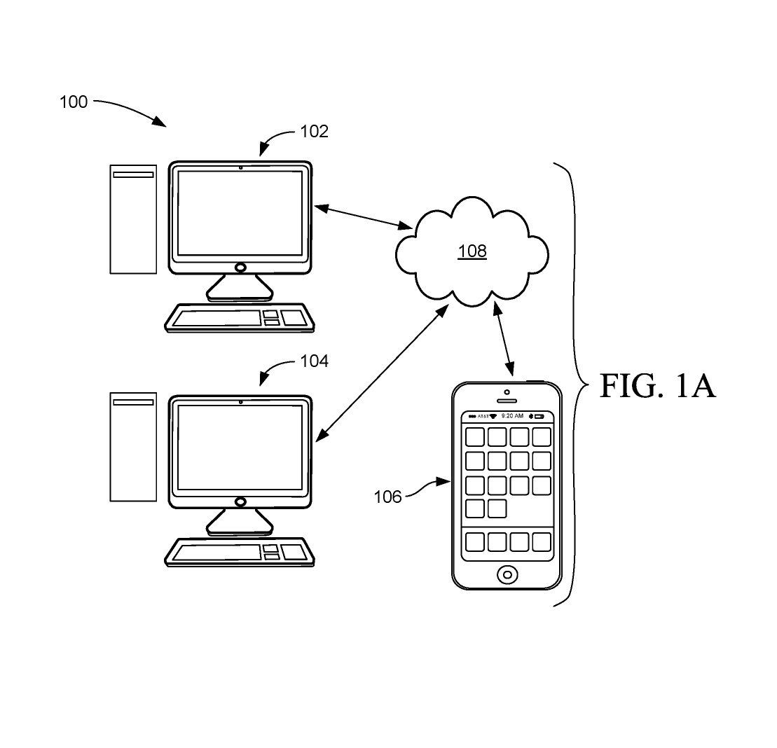

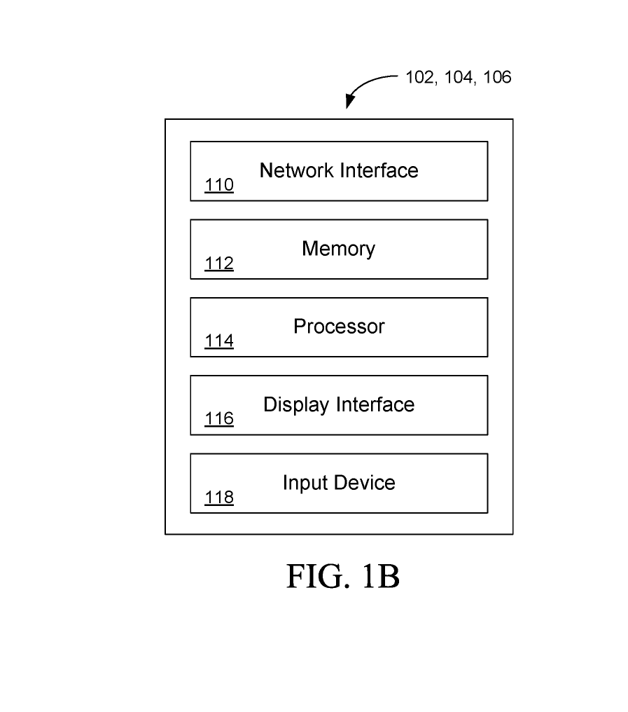

FIG. 1A is an illustrative schematic of one embodiment of the present arrangements that includes a computer platform (hereinafter also referred to as a “Teaching Platform” 100) including multiple computing devices, shown as three exemplar machines 102, 104 and 106. In the embodiment shown in FIG. 1A, computing device 102 is a server and computing devices 104 and 106 are referred to as “client devices.” A network 108 (e.g., the Internet) couples server 102 and client devices 104 and/or 106, to enable communication amongst them. As will be appreciated to those skilled in the art, any computing device (e.g., server, desktop computer, laptop computer, tablet, or mobile device) may be used as one of server 102 and client devices 104 and 106 and configured to perform some or all of the functions contemplated in the present teachings. Furthermore, system 100 may include multiple computing machines to serve the functions of each of server 102 and each of client devices 104 and/or 106.

Representative client devices 104 and 106 (hereinafter sometimes also referred to as “user devices”) include a cellular telephone, a portable digital assistant, a tablet, and/or a stationary computing appliance. In certain embodiments of the present arrangements, each or any one of server 102 and client devices 104 and/or 106 are a wireless machine, which is in wireless communication with network 108. In this embodiment of the present arrangements, a server 102 facilitates interaction and data flow to and from any of client devices 104 and/or 106. In general, server 102 may include one or more computers and data storage devices, and may produce programming instructions, files, or data that may be transmitted over network 108 to client devices 104 and/or 106, which may be used by a user to enter a protocol, to run a protocol, including entering data, and/or analyzing data stored on server 102.

In certain embodiments of the present arrangements, as noted above, Teaching Platform 100 includes several components, including but not limited to a server 102 and a plurality of client devices 104 and/or 106, which are programmed to cooperatively operate a messaging-like communication protocol to provide language lessons as they relate to reading, writing and pronunciation (hereinafter collectively referred to as “teaching content”) between individual users which permits, for example, communications between a plurality of client devices 104 and/or 106 that are each typically operated by one of a plurality of users.

As shown in FIG. 1B, in accordance with one embodiment of the present arrangements, each of server 102 and client devices 104 and 106 include their own network interface 110, a memory 112, a processor 114, a display interface 116, and an input device 118. The present teachings recognize that the network interface 110, memory 112, and processor 114 of each of server 102 and client devices 104 and 106 are configured such that a program stored in memory 112 may be executed by processor 114 to accept input and/or provide output through network interface 110 over network 108 to another server/client device on system 100 of FIG. 1A.

Network interface 110 of each of server 102 and client devices 104 and 106 are used to communicate with another device on system 100 over a wired or wireless network, which may be, for example and without limitation, a cellular telephone network, a WiFi network or a WiMax network or a Blue Tooth network, and then to other telephones through a public switched telephone network (PSTN) or to a satellite, or over the Internet. Memory 112 of devices 102, 104, and/or 106 includes programming required to operate each or any one of server 102 and client devices 104 and/or 106, such as an operating system or virtual machine instructions, and may include portions that store information or programming instructions obtained over network 108, or that are input by the user. In one embodiment of the present arrangements, display interface 116 and input device 118 of client device 106 are physically combined as a touch screen 116/118, providing the functions of display and input.

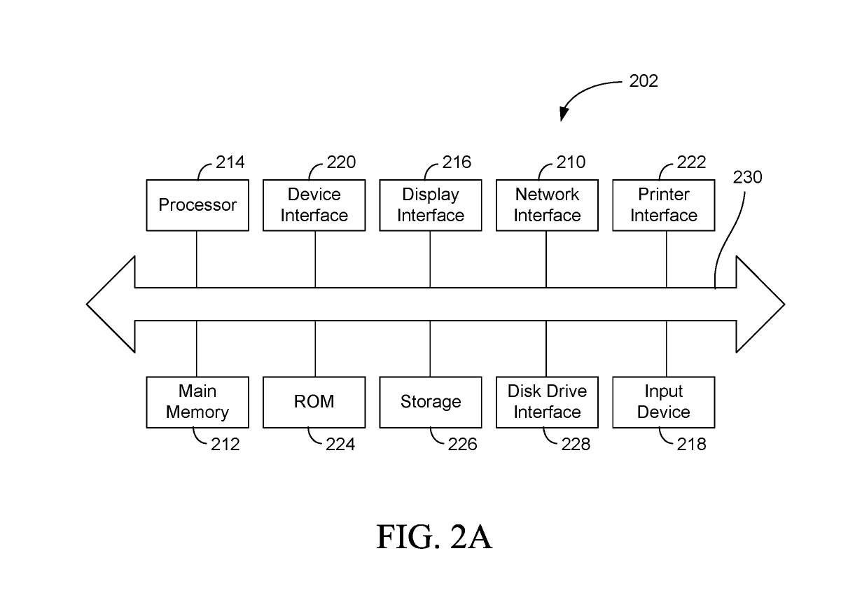

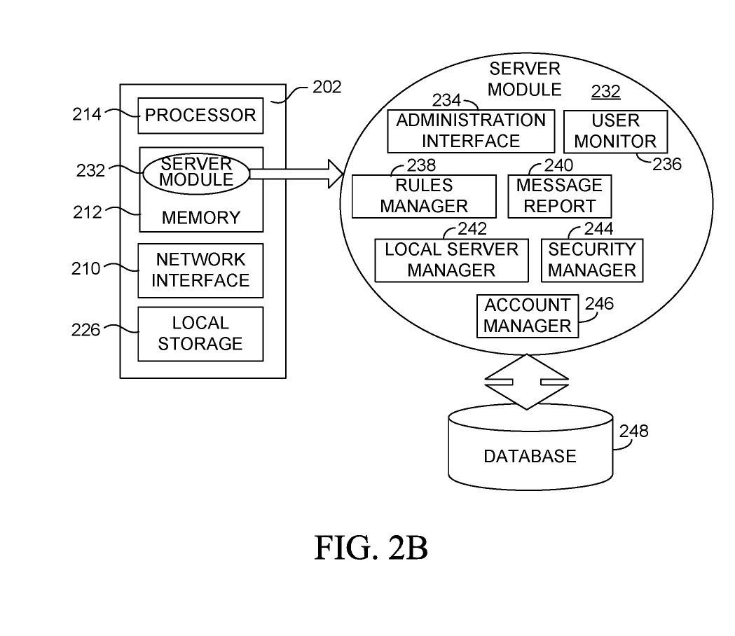

FIG. 2A shows internal construction blocks of a server 202, according to one embodiment of the present arrangements and aspects of the present teachings may be implemented and executed therein. Server 202 is substantially similar to server 102 shown in FIGS. 1A and 1B. Server 202 includes a databus 230 that allows for communication between various modules, such as a network interface 210, a memory 212, a processor 214, a display interface 216, and in input device 218, which are substantially similar to network interface 110, memory 112, processor 114, display interface 116, and input device 118 of FIG. 1B. Furthermore, processor 214 executes certain instructions to manage all components and/or client devices and interfaces coupled to data bus 230 for synchronized operations. A device interface 220 may be coupled to an external device such as another computing machine (e.g., server 102 and client devices 104 and/or 106 of FIG. 1A). In other words, one or more resources in the computing machine may be utilized. Also interfaced to data bus 230 are other modules such as a network interface 210, and a disk drive interface 228. Optionally interfaced to data bus 230 is a display interface 216, a printer interface 222, and one or more input devices 218, such as touch screen, keyboard, or mouse. Generally, a compiled and linked version or an executable version of the present invention is loaded into storage 226 through the disk drive interface 228, the network interface 210, the device interface 220, or other interfaces coupled to the data bus 230.

Main memory 212, such as random access memory (RAM), is also interfaced to the data bus 230 to provide processor 214 with the instructions and access to memory storage 226 for data and other instructions, applications, or services. In particular, when executing stored application program instructions, such as the compiled and linked version of the present invention, processor 214 is caused to manipulate the data to achieve results described herein. A ROM (read only memory) 224, which is also connected to data bus 230, is provided for storing invariant instruction sequences such as a basic input/output operation system (BIOS) for operation of display 216 and input device 218, if there are any. In general, server 202 is coupled to a network and configured to provide one or more resources to be shared with or executed by another computing device on the network or simply as an interface to receive data and instructions from a user, preferably a child.

While FIG. 2A illustrates one embodiment of server 202, it should be noted that not every module shown in FIG. 2A would have to be in server 202 and/or client devices 104 and 106. Depending on the configuration of a specific server 202 or a specific client device 104 and/or 106, some or all of the modules may be used and sufficient.

Referring now to FIG. 2B, there is shown a functional block diagram of server 202, according to one embodiment of the present arrangements, in which a server module 232 resides as software in a memory 212 and is executable by one or more processors 214. According to one embodiment of the present arrangements, server module 232 is provided to memory 212 and executed in server 202 to manage various communications with the client devices 204 and/or 206 and facilitate client devices 204 and/or 206 to capture various activities by a user.

Depending on implementation, server 202 may be a single server or a cluster of two or more servers. Server 202, according to one embodiment of the present arrangements, is implemented as cloud computing, in which there are multiple computers or servers deployed to serve as many client devices as practically possible. For illustration purposes, a representative of a single server 202 is shown and may correspond to server 102 in FIG. 1A. Server 202 includes a network interface 210 to facilitate the communication between server 202 and other devices on a network and a storage space 226. The server module 232 is an executable version of one embodiment of the present invention and delivers, when executed, some or all of the features/results contemplated in the present invention.

According to one embodiment of the present arrangements, server module 232 comprises an administration interface submodule 234, a user monitor submodule 236, a rules manager submodule 238, a message report submodule 240, a local server manager submodule 242, a security manager submodule 244, and/or account manager submodule 246. However, depending on the configuration of server module 232, some or all of the submodules components may be used.

Submodules 234, 236, 238, 240, 242, 244, and 246, when executed on processor 214, allow a user of server 202 with administrator privileges to operate server 102 to perform tasks, which are generally indicated by the submodule names. Thus “administration interface” submodule 234, when executed on server 202, enables a system administrator to register (or add) a user and grant respective access privileges to the users. Administration interface submodule 234 is an entry point to server module 232 from which all sub-modules or the results thereof can be initiated, updated, and managed. By way of example, user A may be allowed to enter his or her selections in connection with the teaching content on his or her client device and receives, on the same client device, a lesson regarding reading, writing and/or pronunciation. As another example, user B may be allowed to enter various selections in connection with the teaching content on a client device, however, user B does not receive any teaching lessons. Instead, the teaching lessons are distributed to another computing device (e.g., computing device 104 of FIG. 1A) to be viewed by another user. In this example, a parent or a teacher guides a child's lessons. As yet another example, a combination of the two examples presented above may be accomplished, i.e., a user's teaching lessons, based on the user's selection, are conveyed to the user and other users. In this example, the parent and/or the teacher are apprised of the child's selection.

In one embodiment, an administrator sets up and manages one or more of the following processes:
the type or nature of inputs the user has access to; and
times at which the user can see or use the inputs.

Account manager submodule 246 has access to a database or an interface to a database 248, maintaining records of registered users and their respective access privileges. Database 248 may be located on server 202 or client device 102 and/or 104. In operation, account manager submodule 246 authenticates a user when the user logs onto server 202 and also determines if the user may access other users. By way of example, when a user tries to log on to server 102, the user is prompted to input confidential signatures (e.g., username and password). Account manager submodule 246 then allows server 202 to verify the confidential signatures. If the confidential signatures are successfully verified, the user is authenticated and is provided access to system 100. In general, account manager submodule 246 is where an operator of system 100 may be able to control its users.

Security manager submodule 244 is configured to provide security when needed. When necessary, messages, data, or files being shared among registered users may be encrypted, thus only authorized user may access the secured messages, data, or files. In certain embodiments of the present arrangements, an encryption key to a secured file is securely maintained in the module and can be retrieved by the system administrator to access a secured document in case the key in a client machine is corrupted or the user or users who have the access privilege to access the secured document are no longer available. In another embodiment, the security manager submodule 244 is configured to initiate a secure communication session when it detects that a registered user accesses a file list remotely over an open network.

User monitor submodule 236 is configured to monitor the status of registered users and generally works in conjunction with account manager submodule 246. In particular, user monitors submodule 236 is configured to manage all registered users as a single group, respective user groups, and individual users in a private user group so that unauthorized users would not get into a group they are not permitted. In addition, user monitor 236 is configured to push or deliver related messages, updates, and uploaded files, if there is any, to a registered user.

Local server manager submodule 242, in some cases, is a collaborative communication platform that needs to collaborate with another collaborative communication platform so that users in one collaborative communication platform can communicate with users in another collaborative communication platform. In this case, a server responsible for managing a collaborative communication platform is referred to as a local server. Accordingly, local server manager submodule 242 is configured to enable more than one local server to communicate. Essentially, server 202 in this case would become a central server to coordinate the communication among the local servers.

Rules manager submodule 238 is used to configure various rules imposed across the system to control communications therein. For example, certain rules are provided to certain users that may capture displays of other client machines without asking for any permission.

A message report manager submodule 240 is configured to record or track all teachings lessons communicated among registered users or groups of users (e.g., parent, child and teacher). These messages are retained for a period of time so that a non-participated user may catch up what was communicated among the users. In one embodiment of the present arrangements, certain types of messages are kept for a predefined time in compliance of regulations or retention of evidences. In operation, message report manager submodule 240 works in conjunction with database 248 and indexes a retained message for later retrieval. In another embodiment of the present arrangements, message report manager submodule 240 is configured to record all types of events that include, but may not be limited to, a time registered user is logged onto and off the system, when an uploaded file or a teaching lesson is accessed by a user.

It should be pointed out that server module 232 in FIG. 2B lists some exemplar modules according to one embodiment of the present invention and not every module in server module 232 has to be implemented in order to practice the present invention. The present teachings recognize that given the description herein, various combinations of the modules as well as modifications thereof, without departing the spirits of the present arrangements, may still achieve various desired functions, benefits and advantages contemplated in the present teachings.

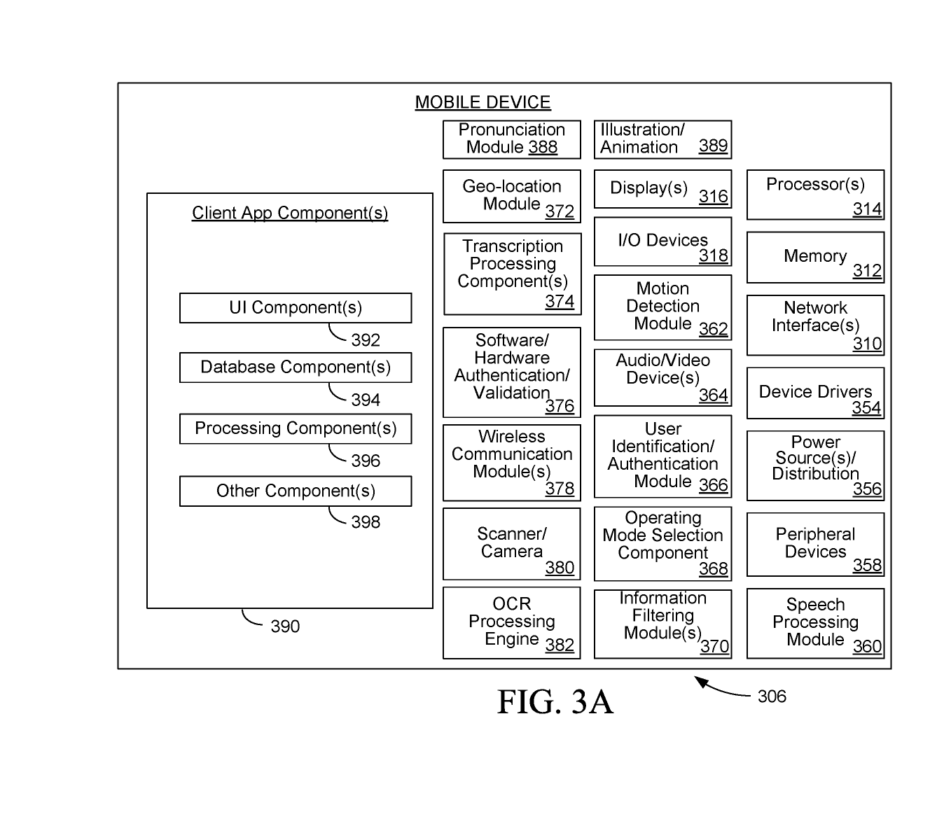

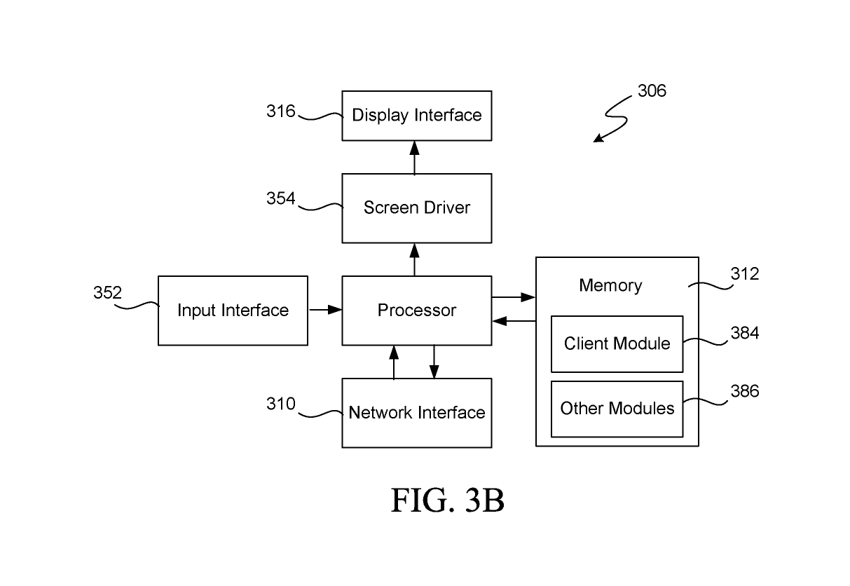

FIG. 3A is a simplified block diagram of an exemplar mobile device 306 in accordance with a one embodiment of the present arrangements. Mobile device 306 is substantially similar to client device 106 of FIG. 1A. Mobile device 306 may include application component(s) that have been configured or designed to provide functionality for enabling or implementing at least a portion of the various teaching lessons at mobile device 306. In at least one embodiment of the present arrangements, mobile device 306 may be operable to perform and/or implement various types of functions, operations, actions, and/or other features such as, for example, one or more of those described and/or referenced herein.

According to certain embodiments of the present arrangements, various aspects, features, and/or functionalities of mobile device 306 is performed, implemented, and/or initiated by one or more of the following types of systems, components, systems, devices, procedures, processes, etc. (or combinations thereof):
Network Interface(s) 310
Memory 312
Processor(s) 314
Display(s) 316
I/O Devices 318
Device Drivers 354
Power Source(s)/Distribution 356
Peripheral Devices 358
Speech Processing module 360
Motion Detection module 362
Audio/Video devices(s) 364
User Identification/Authentication module 366
Operating mode selection component 368
Information Filtering module(s) 370
Geo-location module 372
Transcription Processing Component 374
Software/Hardware Authentication/Validation 376
Wireless communication module(s) 378
Scanner/Camera 380
Processing Engine 382
Pronunciation module 388
Illustration and/or animation module 389
Application Component 390

Network interface(s) 310, in one embodiment of the present arrangements, includes wired interfaces and/or wireless interfaces. In at least one implementation, interface(s) 310 may include functionality similar to at least a portion of functionality implemented by one or more computer system interfaces such as those described herein. For example, in at least one implementation, the wireless communication interface(s) may be configured or designed to communicate with selected electronic game tables, computer systems, remote servers, other wireless devices (e.g., PDAs, cell phones or user tracking transponders). Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID) and/or Infrared and Near Field Magnetics.

Memory 312, for example, may include volatile memory (e.g., RAM), non-volatile memory (e.g., disk memory, FLASH memory, EPROMs, etc.), unalterable memory, and/or other types of memory. In at least one implementation, memory 312 may include functionality similar to at least a portion of functionality implemented by one or more commonly known memory devices such as those described herein. According to different embodiments of the present arrangements, one or more memories or memory modules (e.g., memory blocks) may be configured or designed to store data, program instructions for the functional operations of mobile device 306, and/or other information relating to the functionality of the various teaching lessons described herein. The program instructions may control the operation of an operating system and/or one or more applications, for example.

The memory or memories may also be configured to store data structures, metadata, timecode synchronization information, audio/visual media content, asset file information, keyword taxonomy information, advertisement information, and/or information/data relating to teaching lessons and other features/functions described herein. Because such information and program instructions may be employed to implement at least a portion of the various teaching lessons described herein, various aspects described herein may be implemented using machine-readable media that include program instructions or state information. Examples of machine-readable media include, but are not limited to, magnetic media and magnetic tape, optical media such as CD-ROM disks, magneto-optical media, solid state drives, and hardware devices that are specially configured to store and perform program instructions, such as read-only memory devices (ROM) and random access memory (RAM). Examples of program instructions include both machine code, such as produced by a compiler, and/or files containing higher level code that may be executed by the computer using an interpreter.

In connection with at least one processor 314, in at least one embodiment of the present arrangements, processor(s) 314 may include one or more commonly known processors, which are deployed in many of today's consumer electronic devices. In an alternative embodiment of the present arrangements, at least one processor may be specially designed hardware for controlling the operations of mobile device 306. In a specific embodiment of the present arrangements, a memory (such as non-volatile RAM and/or ROM) also forms part of processor. When acting under the control of appropriate software or firmware, the processor may be responsible for implementing specific functions associated with the functions of a desired network device. Processor 314 preferably accomplishes one or more these functions under the control of software including an operating system, and any appropriate applications software.

In connection with one or more display(s) 316, according to various embodiments of the present arrangements, such display(s) may be implemented using, for example, LCD display technology. OLED display technology, and/or other types of conventional display technology. In at least one implementation, display(s) 316 may be adapted to be flexible or bendable. Additionally, in at least one embodiment of the present arrangements, the information displayed on display(s) 316 may utilize e-ink technology, or other suitable technology for reducing the power consumption of information displayed on the display(s) 316.

One or more user I/O device(s) 318 (hereinafter referred to as an “input/out devices(s)”) provides a user to interact with mobile device 316. By way of example, input/output device(s) 318 may be chosen from a group of devices consisting of keys, buttons, scroll wheels, cursors, touchscreen sensors, audio command interfaces, magnetic strip reader, optical scanner, near field communication, a speaker to transmit an audible sound, and a microphone to receive an audio command. In another embodiment of the present arrangements, input/output device(s) 318 is a camera provided to capture a photo or video, where the data for the photo or video is stored in the device for immediate or subsequent use with other module(s) or application component 390.

In connection with device driver(s) 354, in at least one implementation, the device driver(s) 354 may include functionality similar to at least a portion of functionality implemented by one or more computer system devices such as those described herein. By way of example, display driver 354 takes instructions from processor 314 to drive display screen 316. In one embodiment of the present arrangements, driver 315 drives display screen 316 to display an animated sequence image or images, and/or a conversation between one or more users or play back an animation.

At least one power source (and/or power distribution source) 356, in at least one implementation, the power source may include at least one mobile power source (e.g., battery) for allowing mobile device 306 to operate in a wireless and/or mobile environment. For example, in one implementation, the power source 356 may be implemented using a rechargeable, thin-film type battery. Further, in embodiments where it is desirable for the device to be flexible, power source 256 may be designed to be flexible.

Other types of peripheral devices 358, which may be useful to the users of various mobile devices 306, such as, for example: PDA functionality; memory card reader(s); fingerprint reader(s); image projection device(s); and social networking peripheral component(s).

Speech processing module 360 may be included, which, for example, may be operable to perform speech recognition, and may be operable to perform speech-to-text conversion.

Motion detection component 362 may be implemented for detecting motion or movement of mobile device 306 and/or for detecting motion, movement, gestures and/or other input data from user. In at least one embodiment of the present arrangements, the motion detection component 361 may include one or more motion detection sensors such as, for example, MEMS (Micro Electro Mechanical System) accelerometers, that may detect the acceleration and/or other movements of mobile device 306, as a user moves it.

Audio/video device(s) 364 such as, for example, components for displaying audio/visual media which, for example, may include cameras, speakers, microphones, media presentation components, wireless transmitter/receiver devices for enabling wireless audio and/or visual communication between mobile device 306 and remote devices (e.g., radios, telephones or computer systems). For example, in one implementation, the audio system may include componentry for enabling mobile device 306 to function as a cell phone or two-way radio device.

In one implementation of the present arrangements, user identification/authentication module 366 is adapted to determine and/or authenticate the identity of the current user or owner of mobile device 306. For example, in one embodiment, the current user may be required to perform a log-in process at mobile device 306 in order to access one or more features. Alternatively, mobile device 306 may be adapted to automatically determine the identity of the current user based upon one or more external signals such as, for example, an RFID tag or badge worn by the current user, which provides a wireless signal to mobile device 306 for determining the identity of the current user. In at least one implementation of the present arrangements, various security features may be incorporated into mobile device 306 to prevent unauthorized users from accessing confidential or sensitive information regarding the user or otherwise.

Operating mode selection component 368, which, for example, may be operable to automatically select an appropriate mode of operation based on various parameters and/or upon detection of specific events or conditions such as, for example: mobile device's 306 current location; identity of current user; user input; system override (e.g., emergency condition detected); proximity to other devices belonging to same group or association; and proximity to specific objects, regions and zones. Additionally, the mobile device may be operable to automatically update or switch its current operating mode to the selected mode of operation. Mobile device 306 may also be adapted to automatically modify accessibility of user-accessible features and/or information in response to the updating of its current mode of operation.

Information filtering module(s) 370, which, for example, may be adapted to automatically and dynamically generate, using one or more filter parameters, filtered information to be displayed on one or more displays of the mobile device. In one implementation of the present arrangements, such filter parameters may be customizable by a user of the device. In some embodiments of the present arrangements, information filtering module(s) 370 may also be adapted to display, in real-time, filtered information to the user based upon a variety of criteria such as, for example, geo-location information, proximity to another user in a group and/or by time.

Geo-location module 372 which, for example, may be configured or designed to acquire geo-location information from remote sources and use the acquired geo-location information to determine information relating to a relative and/or absolute position of mobile device 306. Geo-location may be determined, for example, by GPS, WI-FI, or a cellular network.

Transcription processing component(s) 374 which, for example, may be operable to automatically and/or dynamically initiate, perform, and/or facilitate transcription of audio content into corresponding text-based content. In at least one embodiment of the present arrangements, transcription processing component(s) 374 may utilize the services of one or more remote transcription servers for performing at least a portion of the transcription processing. In at least one embodiment of the present arrangements, application component 390 includes a teaching lesson application that may initiate transcription of audio content, for example, via use of an application program interface (“API”) to a third-party transcription service. In some embodiments of the present arrangements, at least a portion of the transcription may be performed at the user's mobile device 306.

In one implementation of the present arrangements, the wireless communication module 378 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), and Infrared and Near Field Magnetics.

Software/Hardware Authentication/validation components 376, which, for example, may be used for authenticating and/or validating local hardware and/or software components, hardware/software components residing at a remote device, user information, and/or identity.

In accordance with one embodiment of the present arrangements, scanner/camera component(s) 380, which may be configured or designed for use in capturing images, recording video, scanning documents or barcodes, may be used.

OCR Processing Engine 382, for example, may be operable to perform image processing and optical character recognition of images such as those captured by a mobile device camera, for example.

In one embodiment of the present arrangements, pronunciation module 388 produces selectable words. In other embodiments of the present arrangements, pronunciation module 388 provides a phonetic pronunciation of a letter and/or says the name of the letter.

In one embodiment of the present arrangements, illustration and/or animation module 389 provides illustrations and/or one or more animated sequences, described herein.

As illustrated in the example of FIG. 3A, mobile device 306 may be implemented as a mobile or handheld computing device, which includes a variety of components, modules and/or systems for providing various functionality. For example, mobile device 306 may include application components 390, which may include, but are not limited to, one or more of the following (or combinations thereof):
UI components 392 such as those illustrated, described, and/or referenced herein.
Database components 394 such as those illustrated, described, and/or referenced herein.
Processing components 396 such as those illustrated, described, and/or referenced herein.
Other components 398, which, for example, may include components for facilitating and/or enabling mobile device 306 to perform and/or initiate various types of operations, activities, and functions such as those, described herein.

In at least one embodiment of the present arrangements, teaching lesson application component(s) 390 may be operable to perform and/or implement various types of functions, operations, actions, and/or other features such as, for example, one or more of the following (or combinations thereof):
Teaching lesson application 390 may be installed and operated at a user's mobile communication device such as a mobile telephone/smart phone device;
Teaching lesson application 390 presents configuration options, which may include, but are not limited to, hours of operation, pre-selected user's names for the use with the system, options related to time constraints associated with the application's functions and/or features, rules for selecting individual contact records and user's previous selections within a particular teaching lesson, amongst other options;
Teaching lesson application 390 may operate continually in the background during user-specified times of operation;
In one embodiment of the present arrangements, teaching lesson application 390 provides an interface to collect audio recording of and/or transcription of the audio recording to text;
In one embodiment of the present arrangements, teaching lesson application 390 transcribes audio dictation to text locally at the mobile device;
Teaching lesson application 390 may assemble input data, including but not limited to, user's selection data, voice audio data, transcribed text data in to multiple formats, locational data, GPS data, time and date data, video and/or graphic information;
In one embodiment of the present arrangements, information may be conveyed in a variety of different electronic mediums and networks, which may include the Internet, wireless networks and/or private/proprietary electronic networks;
Teaching lesson application 390, in certain embodiments of the present arrangements, may be configured or designed to facilitate access to various types of communication networks such as, for example, one or more of the following (or combinations thereof): the internet, wireless networks, a private electronic networks, or proprietary electronic communication systems, cellular networks, and/or local area networks;
In one embodiment of the present arrangements, teaching lesson application 390 may automatically access various types of information at the user's mobile communication device such as, for example, one or more of the following (or combinations thereof): audio data, video data, motion detection, GPS data and/or user profile data;
In at least one embodiment of the present arrangements, teaching lesson application 390 may be operable to access, send, receive, store, retrieve, and/or acquire various types of data, which may be used at the user's mobile device and/or by other components/systems of the Teaching Platform; and
In at least one embodiment, teaching lesson application 390 may communicate with a computer system (e.g., computer system 100 of FIG. 1A) to automatically perform, initiate, manage, track, store, analyze, and/or retrieve various types of data and/or other information (such as, for example, selections of certain words for pronunciation and/or tracing) which may be generated by (and/or used by) teaching lesson application 390.

According to certain embodiments of the present arrangements, multiple instances of teaching lesson application 390 may be concurrently implemented and/or initiated via the use of one or more processors and/or other combinations of hardware and/or hardware and software. By way of example, in at least some embodiments of the present arrangements, various aspects, features, and/or functionalities of the teaching lesson application component(s) 390 are performed, implemented and/or initiated by one or more of the following types of systems, components, systems, devices, procedures, and processes described and/or referenced herein.

In at least one embodiment of the present arrangements, at least a portion of the database information may be accessed via communication with one or more local and/or remote memory devices (e.g., memory 212 and database 248 of FIG. 2B). Examples of different types of input data, which may be accessed by teaching lesson application 390 component(s), may be chosen from a group comprising media, voice audio data, transcribed text data, GPS/locational data, touch, movement, time and date data, animation and graphic information. Teaching lesson application 390 may also automatically obtain input data from a remote server (e.g., server 102 of FIG. 1A) or database (e.g., database 248 of FIG. 2B), including but not limited to selection of teaching lessons.

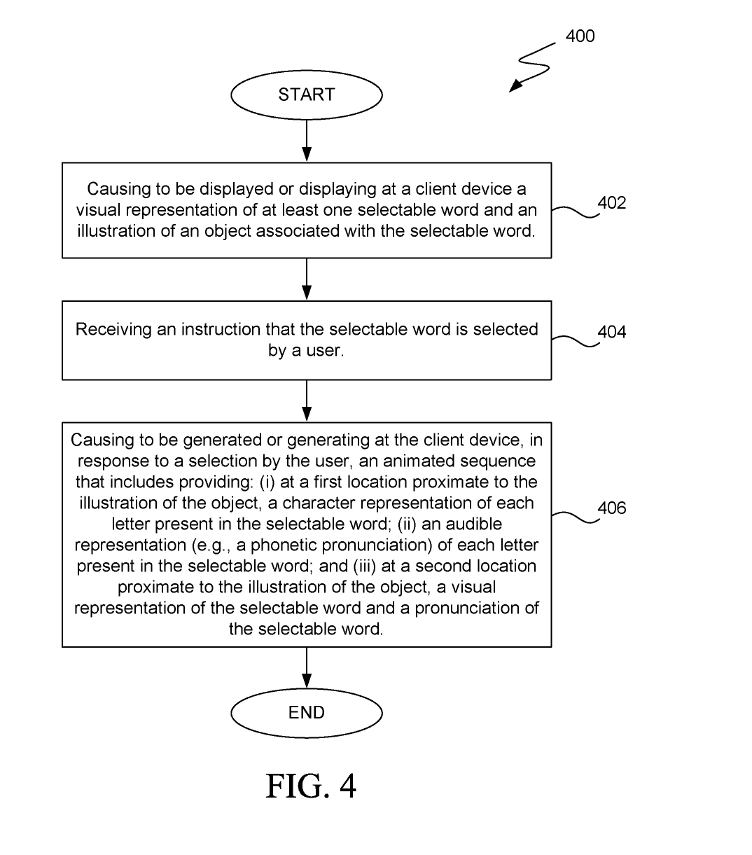

Referring now to FIG. 3B, an internal functional block diagram illustrates a client device 306 that may be used with a computer system (e.g., computer system 100 of FIG. 1) according to one embodiment of the present arrangements. Client device 306 is substantially similar to client device 306 of FIG. 3A but includes a client module 384 and other modules 386. According to one implementation, client module 384 and other modules 386 are loaded in memory 312, and when executed by processor 314, delivers features, advantages, and benefits contemplated by the present arrangements (e.g., have information regarding the different teaching lessons as described in FIGS. 4, 5A-5E, 6, 7A-7J, 8, 9, 10A-10C, 11A-11D, 12A-12, and 13A-13D). By way of example, client module 384, when executed by processor 314, receives a selection in connection with a teaching lesson that is processed at processor 314 and/or conveyed to a server (e.g., server 102 of FIG. 1A) to provide information regarding selected teaching lessons. As will be further described below, visual and/or audible representations of one or more teaching lessons may be simply viewed, heard, and/or interacted with by the user.

In one embodiment of the present arrangements, client module 384 is uniquely designed, implemented, and configured to dynamically change the visual and/or audible representations of a user or a group of user's teaching lessons. The present teachings recognize that the process of visually displaying or audibly providing a user's or a group of users' teaching lessons is not something a general computer is capable of performing by itself. A general computer must be specifically programmed or installed with a specifically designed module such as client module 312, according to one embodiment of the present arrangements, to perform this process. To this end, in certain embodiments of the present arrangements, server module 384 of FIG. 3B and client module 232 of FIG. 2B include instructions to cooperatively achieve one or more of the following specialized functions: 1) the operating of the above-mentioned Teaching Platform 100 to provide teaching lessons to a particular user; 2) making selections, through screens and input devices of client devices 104 and/or 106 of FIG. 1A, within a teaching lesson; 3) conveying information relating to one or more teaching lessons and/or a visual/audible representation associated with it to one or more client devices and/or server(s); and/or 4) facilitating visual and audible representations of teaching content relating to teaching lessons on one or more client devices. Moreover, in those instances when a teaching lesson is effectively generated and/or expressed on a client device in real-time, i.e., contemporaneously with the receipt of one or more selection inputs, the role of a client module, as described herein, becomes significant and a general purpose computer is not capable of performing by itself.

FIG. 4 is a flowchart showing certain salient steps of a process 400, according to one embodiment of the present teachings, for teaching pronunciation and/or reading of a word. Process 400 begins with a step 402, which includes causing to be displayed or displaying at a client device a visual representation of at least one selectable word and an illustration of an object associated with the selectable word. Preferably, step 402 is carried by a server (e.g., computing device 102 of FIG. 1A), or a processor in a client device (e.g., processor 102 of FIG. 1B), that causes to be displayed or displays the selectable word and associated object on a client device's display interface (e.g., display interface 116 of FIG. 1B).

A client device is substantially similar to its counterpart described above with reference to client devices 104 and 106 of FIG. 1A. According to preferred embodiments of the present teachings, implementation of step 402 on a client device is carried out by presenting a selectable word and an associated object in the context of an illustrated and/or animated children's story. This provides the advantage of teaching children language lessons (i.e., pronunciation and/or reading of words and letters) in an engaging and entertaining context that captures and maintains a child's attention throughout the language lesson, and motivates the child to continue through the story (and thus to subsequent language lessons presented in the context of that story).

As used herein, the term “user” may be thought of as any individual who uses an electronic device that carries out and/or implements the methods of the present teachings. In preferred embodiments of the present teachings, a user is a child who is using an electronic device that is programmed and/or configured to teach that child how to pronounce and/or read letters and words presented in the context an illustrated and/or animated story.

As used herein, the term “selectable word” is a word that a user may select to learn its pronunciation and/or reading in a sentence. Preferably, the user learns how to pronounce and/or read the selectable word within the context of an illustrated or animated story presented on an electronic device. A selectable word, then, may be thought of as a word presented in an illustrated or animated story that a user selects to begin or continue a pronunciation and/or reading lesson (i.e., a language lesson) about that word. Preferably, a selectable word contains one or more letters.

As used herein, the term “object” is a depiction of what is conveyed by a selectable word. By way of example, if a selectable word is “dad,” then an object is a depiction of a dad. Preferably, a selectable word and its corresponding object are part of an animation or illustration of a story and/or a story scene.

Next, a step 404 includes receiving an instruction that the selectable word has been selected by a user. According to certain embodiments of the present teachings, a user selects a selectable word by clicking or tapping the selectable word on a display screen. In an alternate embodiment of the present teachings, a selectable word is selected when a user clicks or taps an object associated with the selectable word. Selection of a selectable word by a user prompts the systems of the present teachings and arrangements to begin an animated sequence on a client device's viewing display that provides a language lesson to the user.

To this end, a step 406 includes causing to be generated or generating at the client device, in response to a selection by the user, an animated sequence that includes providing: (i) at a first location proximate to the illustration of the object, a character representation of each letter present in the selectable word; (ii) an audible representation of each letter present in the selectable word; and (iii) at a second location proximate to the illustration of the object, a visual representation of the selectable word and a pronunciation of the selectable word. In certain embodiments of the present teachings, the first location in part (i) and the second location in part (iii) are the same.

As used herein, the term “character representation” means a representation of a letter, in a selectable word, in the form of a human-like and/or animated character or some other unique depiction of the letter. The present teachings recognize that a character representation of a letter may be used to provide children an engaging and entertaining way of participating in a language lesson, particularly when a character representation is presented in the context of a children's story, and/or when a character representation carries out certain movements, gestures, or changing states when used in a language lesson and/or an illustrated story. The present teachings further recognize, then, that under these circumstances, a child will be more motivated to participate in and complete language lessons, and the language lessons that are taught will be more likely retained by a child. In particular, using character representation in such manner may engender participative feelings in a child and that she or he is part of a story.

A character representation may include one or more anthropomorphic features or characteristics, such as eyes, eyebrows, hair, a mouth, feet, and any other feature associated with the human or an animal form. Further, a character representation may be presented as an animation that moves, speaks, and/or changes form and/or color. Further still, a character representation may be presented as an animation or illustration that produces and/or pronounces sounds associated with letters and words, and/or makes certain gestures or movements while producing and/or pronouncing such sounds. The present teachings recognize that animations of character representations may be programmed to carry out and/or display any feature, characteristic, or behavior associated with a human being, with an animal, or with a cartoon character.

According to the systems and methods of the present teachings, a letter in a selectable word may be depicted as a character representation or a textual representation. A textual representation may be thought of as a letter or word that appears simply as text, including stylized text, but that lacks the character features associated with a character representation. In certain embodiments of the present teachings, a word may be presented as having a certain letter or letters depicted as textual representations, and certain other letter or letters depicted as character representations. This use of character representations and textual representation in a word provides the advantage of stressing or emphasizing the letters or words presented as character representations over those presented as textual representations.

In certain embodiments of the present teachings, process 400 may include a further step of causing to be displayed or displaying, at the client device, an indication that the selectable word is selected. For example, after the user has selected a selectable word, an indication of the selection may be provided as an animation that depicts an illustration of a human hand tapping on the selectable word, a tapping or clicking sound associated with the selection, or lines radiating outward from the selectable word or the object associated with the selectable word.

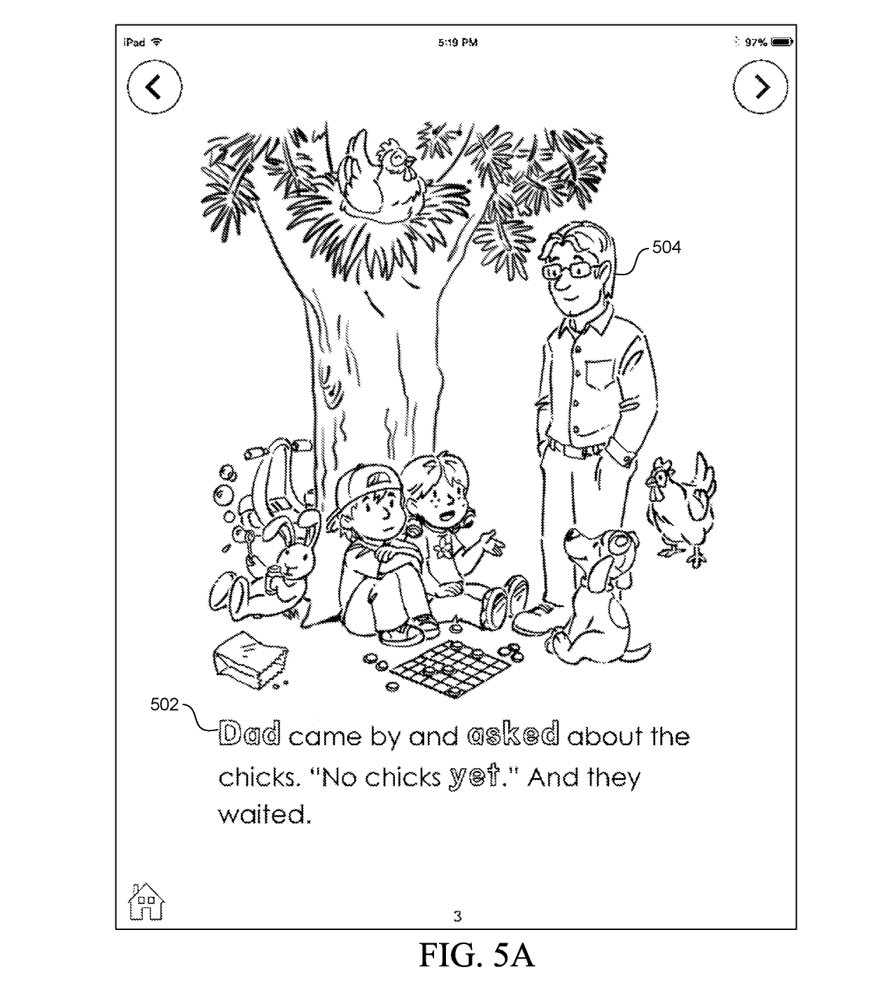

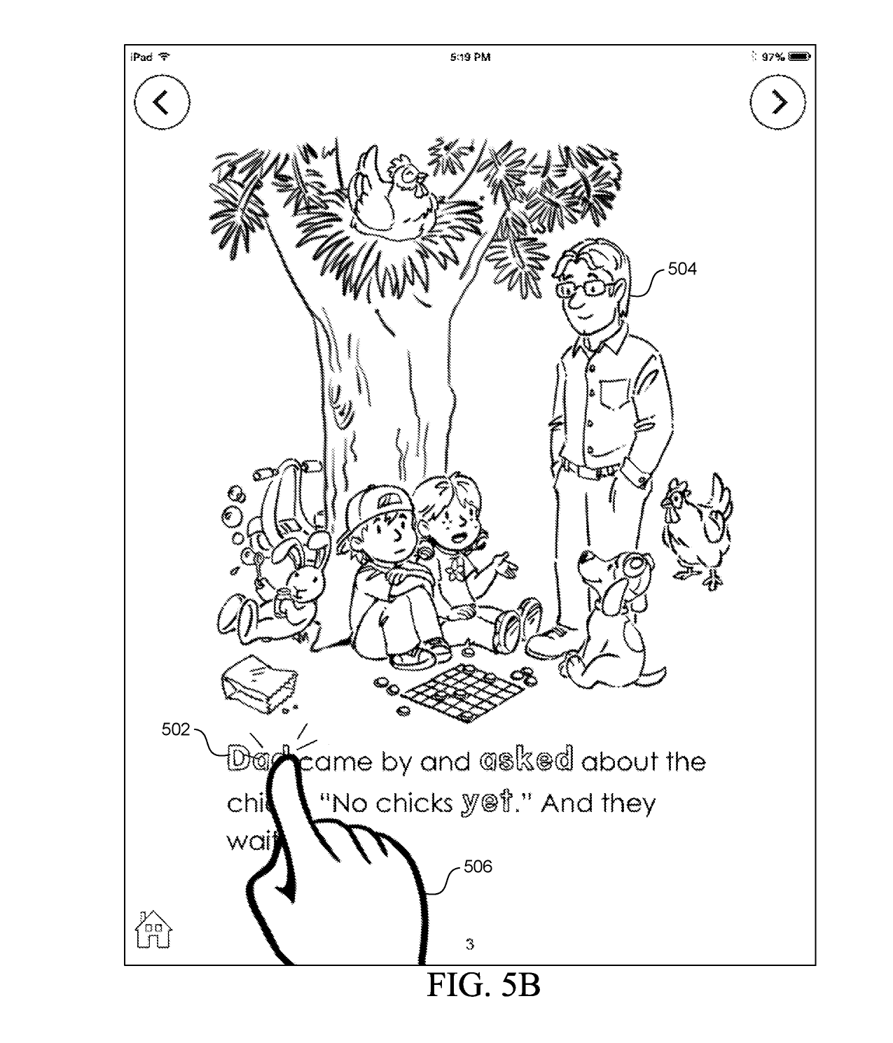

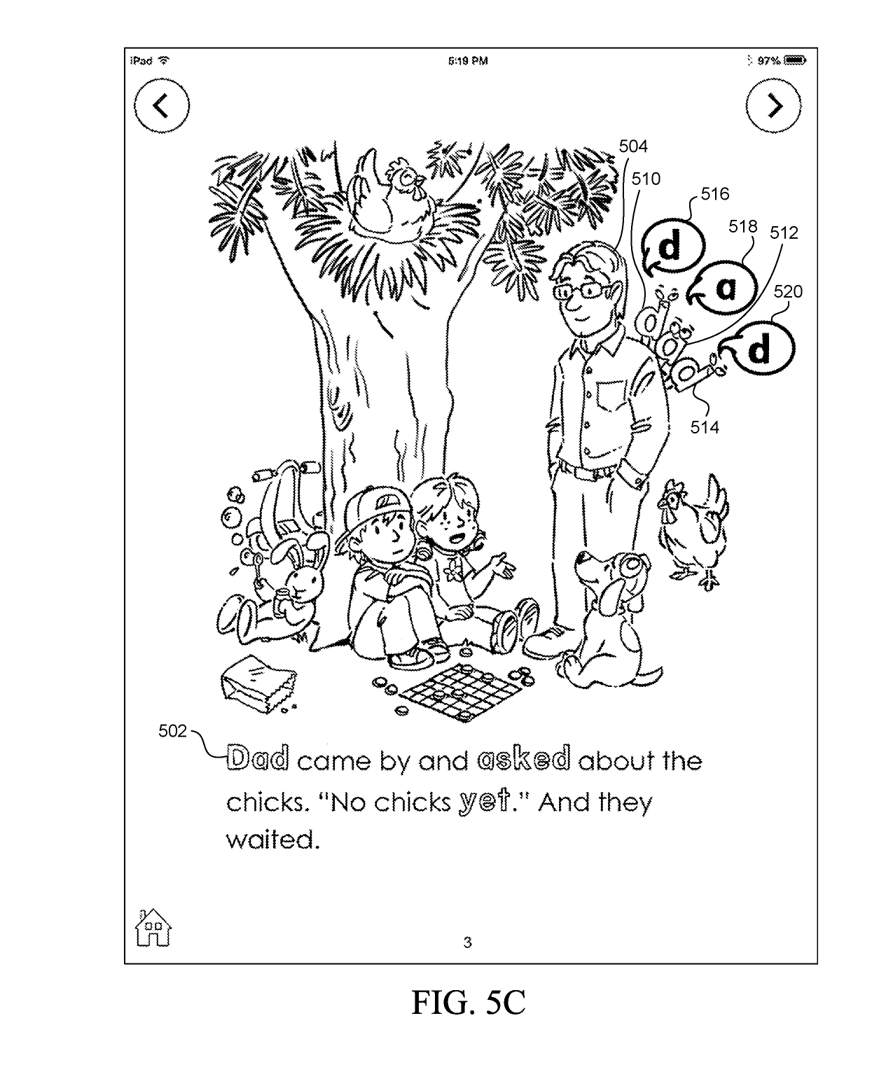

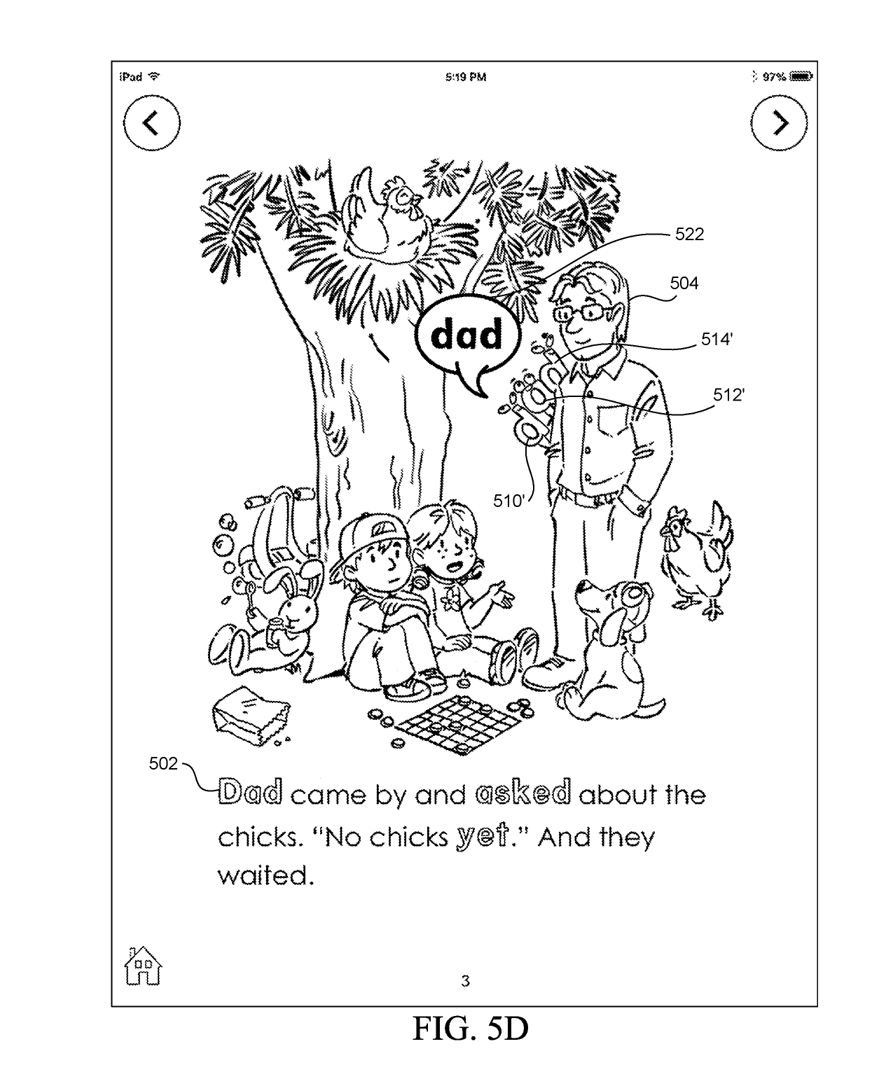

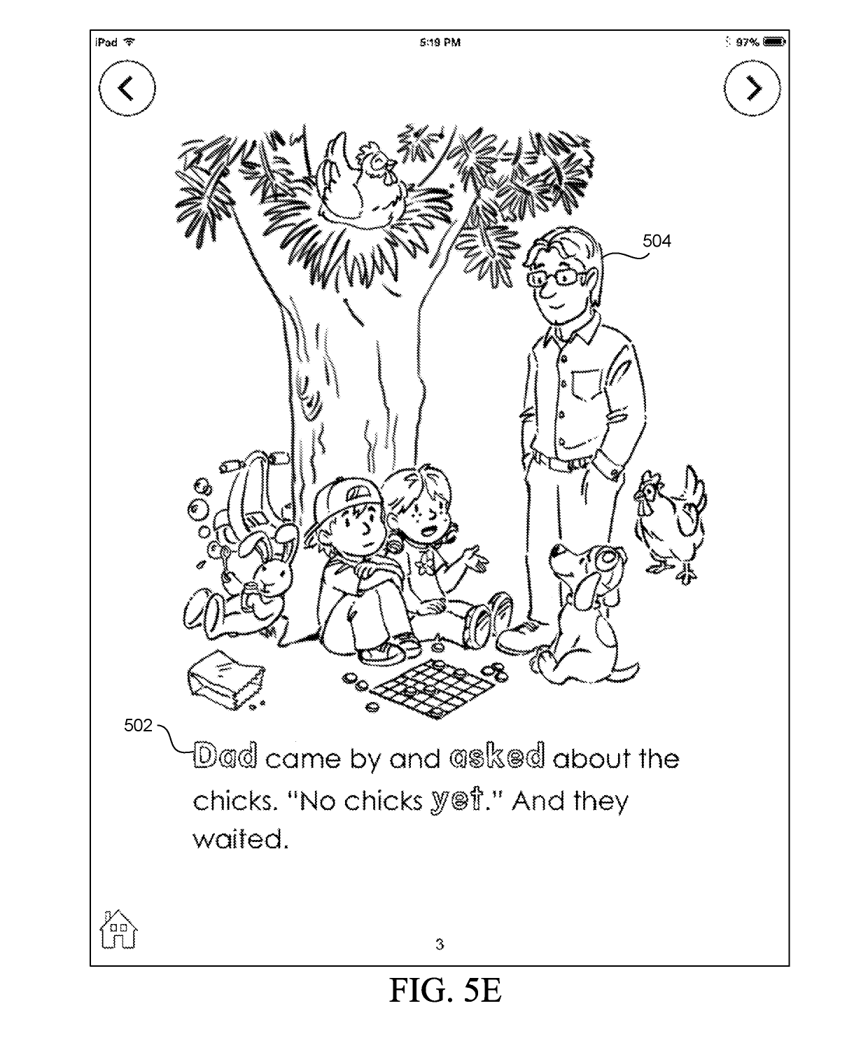

As shown in further detail below in FIGS. 5A-5E, an audible representation of a letter in a selectable word may be an audible representation of a phonetic sound associated with the letter, preferably when pronounced in the context of a selectable word, and/or an audible representation that simply states a name of the letter.

Further, the audible representation of each letter and/or the pronunciation of the selectable word presented to the user may be accompanied by a depiction of the character representation in a modified state. In other words, and according to certain embodiments of the present teachings, as the selectable word or any letter therein is pronounced, the character representations of the present teachings may be depicted as shaking, shrinking, expanding, condensing, enlarging, turning, changing color, speaking, and/or moving. In a similar manner, a character representation of a letter may be presented as speaking the sound associated with the letter (i.e., the sound associated with pronouncing the letter when it is in the context of a selectable word).

FIGS. 5A-5E are various exemplar screenshots provided by the systems of the present arrangements and showing a computer-generated animated story that uses character representations of letters to teach pronunciation of words to children according to the embodiment of FIG. 4. FIGS. 5A-5E show sequential screenshots of the touchscreen of a tablet computer (e.g., an iPad) that illustrates the results of programing that interactively teaches pronunciation and/or reading to a user in the context of an animated story. In other embodiments of the present teachings, however, teaching pronunciation and/or reading to a user is done in the context of a dictionary that is stored in the memory of a client device and/or server. In other words, a selectable word may be selected from a dictionary listing of selectable words to carry out a language lesson.

FIG. 5A shows a screenshot of an animated story displayed on a client device. FIG. 5A includes a selectable word 502, “Dad,” presented as a textual representation in the context of a sentence that is part of a story that is generated on the viewing display of a client device. Though not labeled for the sake of simplicity, the sentence also includes other selectable words, such as “asked” and “yet,” which like selectable word 502, are portrayed as larger, stylized, and/or having a different color than the surrounding words, thus indicating that those selectable words may also be selected by a user.

FIG. 5A also includes an illustration of an object 504, which is an illustration of “dad” that is associated with selectable word 502 in a sentence below the illustration. Though not labeled for the sake simplicity, FIG. 5A (as well as subsequent FIGS. 5B-5D) also include illustrations of several other characters and items used to facilitate the presentation of a story, such as a tree, various animals, a paper bag, a game board and accompanying pieces, and a scooter.

FIG. 5A may be thought of as a screenshot that is displayed as part of a story that a user reads or is reading prior to the initiation of a language lesson. Prior to this screenshot, a user may have initiated a story program. The user may navigate to various pages on the story using the forward arrow in the upper right corner and the backward arrow in the upper left corner. The user may also return to a home screen by touching the house symbol in the lower left corner.

FIG. 5B is a screenshot that shows a selectable word being selected by a user (e.g., as described above with reference to step 404 of FIG. 4). FIG. 5B includes a user icon 506, which is presented in the shape of a stylized hand, and indicates that by tapping the stylized hand on a selectable word, a user has selected selectable word 502. In other embodiments of the present teachings, however, user icon 506 is absent and upon selection of a selectable word by the user, radiating lines surrounding the selected word appears to draw attention to the selection. Though not indicated in FIG. 5B, selection of a selected word may also or alternately be accompanied by a sound, such as a “tapping” or a “clicking” sound. The present teachings recognize that any means of depicting selection of a selectable word may be used.

Next, selection of the selectable word provides an instruction (e.g., to a server and/or to programming executable from the client device) that the user has selected the selectable word. This selection prompts initiation of a program that produces an animated sequence on the touchscreen display. To this end, the screenshot in FIG. 5C shows an animation that facilitates teaching a user how to pronounce the sounds that comprise the word “dad.”

FIG. 5C includes a character representations 510 of the letter “d,” a character representation 512 of the letter “a,” and a character representation 514 of the letter “d” (i.e., the second “d” in the word “dad”). They are collectively disposed at a location proximate to the left shoulder of object 504. FIG. 5C also includes a sound bubble 516 for the letter “d,” another sound bubble 518 for the letter “a,” and yet another sound bubble 520 for the letter “d.”

The depiction of a letter in a sound bubble, which is shown in FIG. 5C, means that an audible representation is delivered using a sound clip through an audio output (e.g., audio/video device 364 of FIG. 3A, or a speaker) and is heard by a user; the user, however, does not see necessarily see the sound bubbles shown in this figure, though in other embodiments of the present teachings, one or more sound bubbles are displayed on a user device's display screen to facilitate teaching of pronunciation (e.g., by conveying visually that a character representation is pronouncing or making sound depicted in a sound bubble). A sound bubble is also depicted with a pointed portion pointing towards a character representation and thereby indicating that the character representation is speaking or sounding out the letter associated with the character representation. In other embodiments of the present teachings, one or more of the character representations can pronounce the selectable word. Thus, as shown in FIG. 5C, character representation 510 is depicted as pronouncing a phonetic “d” sound from the word “dad,” character representation 512 is depicted as pronouncing the next phonetic “a” sound from the word “dad,” and character representation 514 is depicted as pronouncing the next phonetic “d” sound from the word “dad.” In such manner, a child is presented a step-by-step breakdown of how to pronounce any selectable word. This step-by-step presentation of the pronunciation of the word “dad” may also teach and/or reinforce for children the spelling and/or reading of the word “dad.” In those embodiments used to teach reading and/or spelling of a word, sound bubbles 516, 518, and 520 may also or alternately be presented as audible representations specifically pronouncing the names of letters “d,” “a,” and “d,” respectively.

Thus, the animated sequence is programmed to associate the selected word in the story with the story image and to teach pronunciation and/or spelling of the letters that form the selectable word.

Next, the screenshot of FIG. 5D is used to teach the user how to join the “d,” “a,” and “d” phonetic sounds taught in FIG. 5C to pronounce the word “dad.” FIG. 5D includes a character representation 510′ of the letter “d,” a character representation 512′ of the letter “a,” and a character representation 514′ of the letter “d.” Character representations 510′, 512′, and 514′ are substantially similar to their counterparts in FIG. 5C, i.e., character representations 510, 512, and 514, respectively, though character representations 510′, 512′, and 514′ are shown disposed proximate to the right shoulder of object 504. In certain embodiments of the present teachings, the animated sequence may include these character representations walking, marching, or otherwise moving from the left shoulder to the right shoulder of object 504.

In the animated sequence of the present teachings, FIG. 5D is accompanied by a sound bubble 522, which depicts delivery, through an audio output, of pronunciation of the word “dad.” In other words, following the pronunciation of each letter and/or spelling of the word “dad” presented in FIG. 5C, the user is taught the full pronunciation of the word “dad” in FIG. 5D. The animated sequence may also show other changes, such as surprise by the dad, surprise by the children, or any other change that may facilitate teaching pronunciation to the user, or to provide entertainment to the user so as to motivate the user to continue the story and the associated language lesson(s).

The screenshot in FIG. 5D is presented on the client device when the user has completed or otherwise ended the language lesson taught in FIGS. 5B-5D. FIG. 5D, which includes selectable word 502 and object 504, may be thought of as the same as or substantially similar to the screenshot shown in FIG. 5A. In other words, the user leaves the story at FIG. 5A, participates in a language lesson in FIGS. 5B-5D, and returns to the story at the screenshot presented in FIG. 5E.

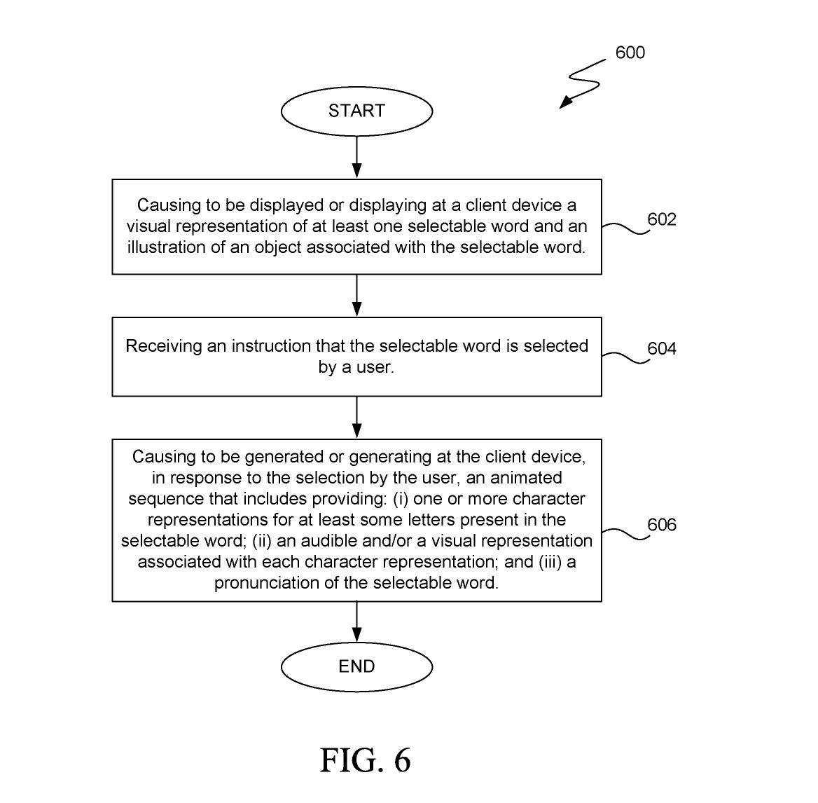

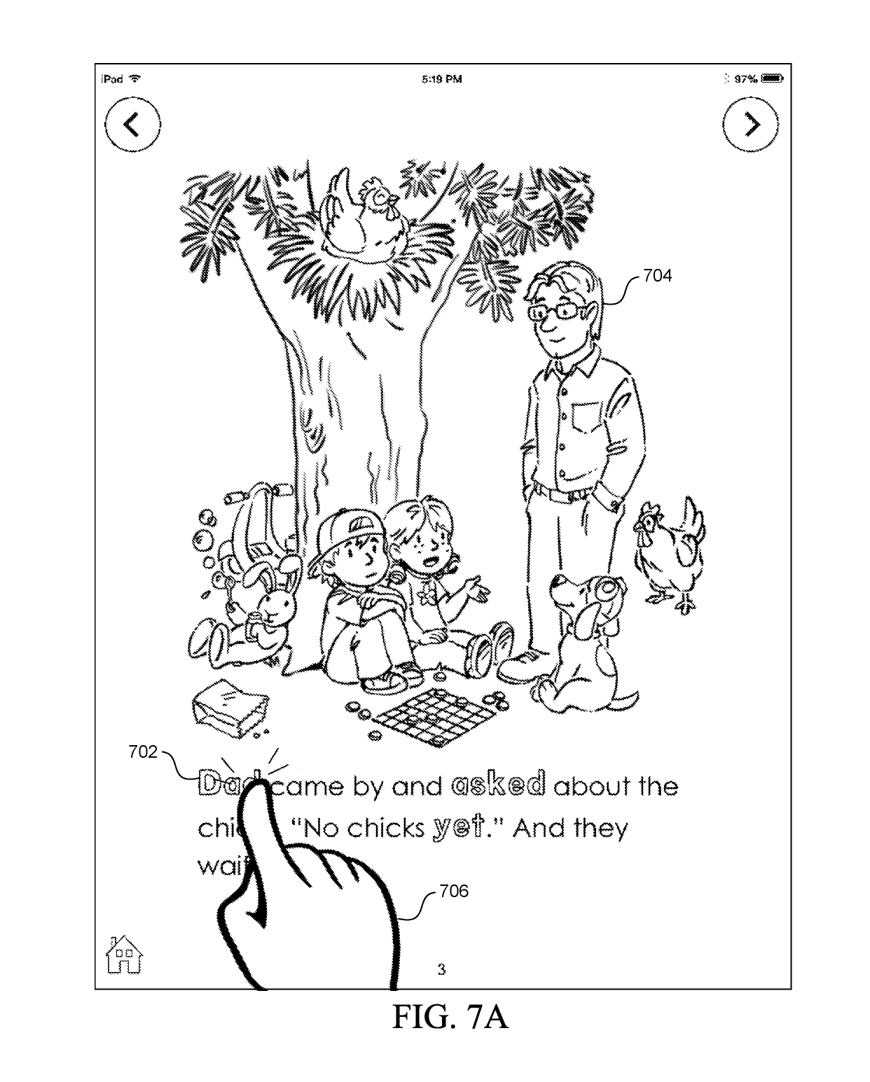

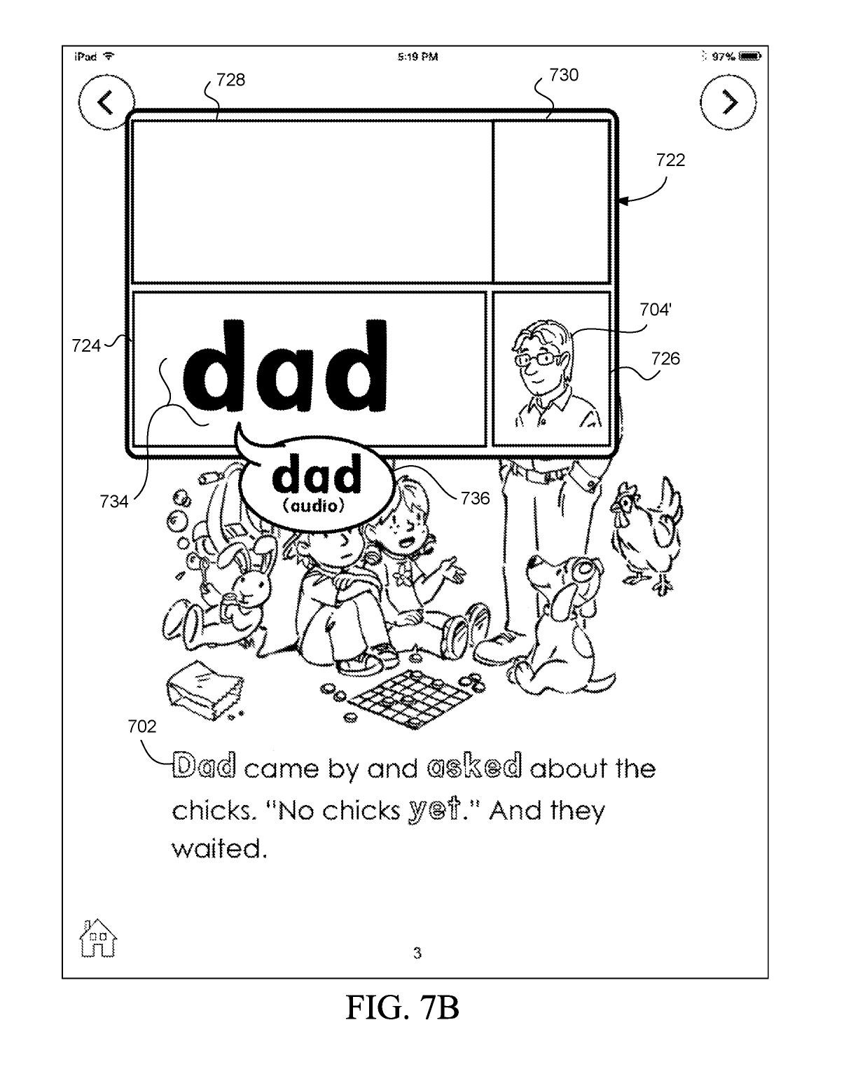

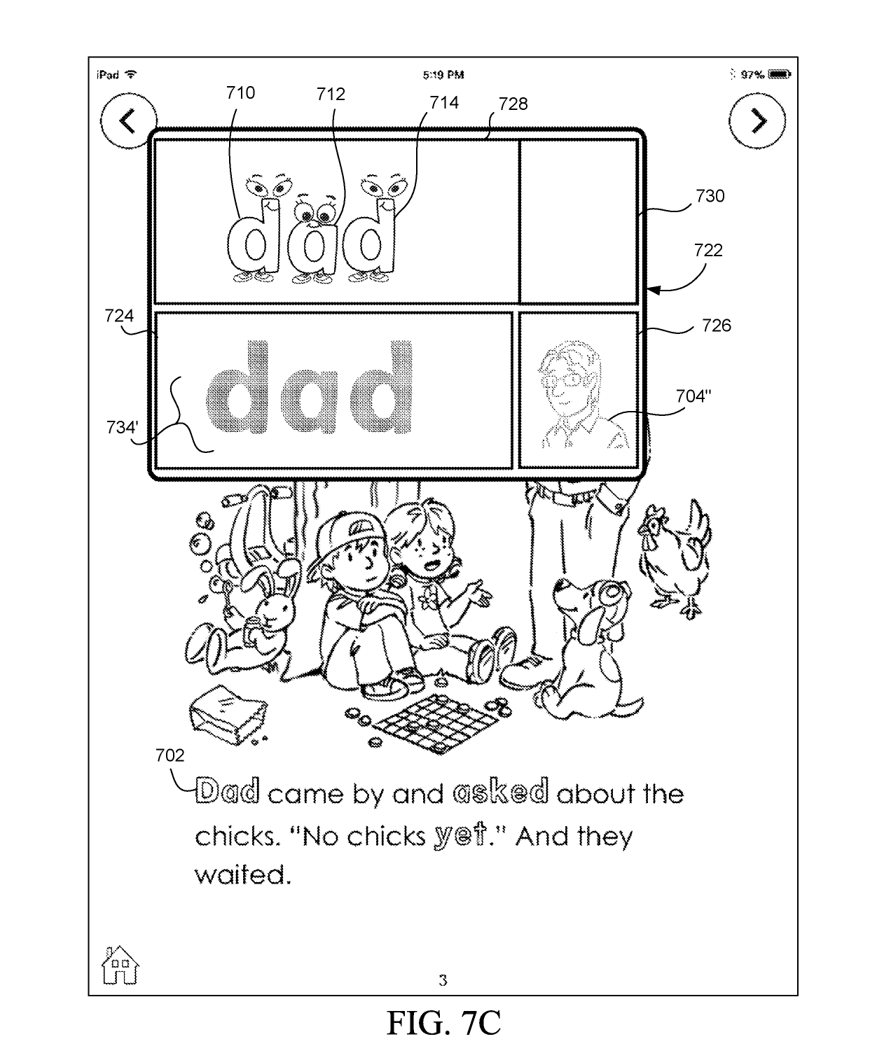

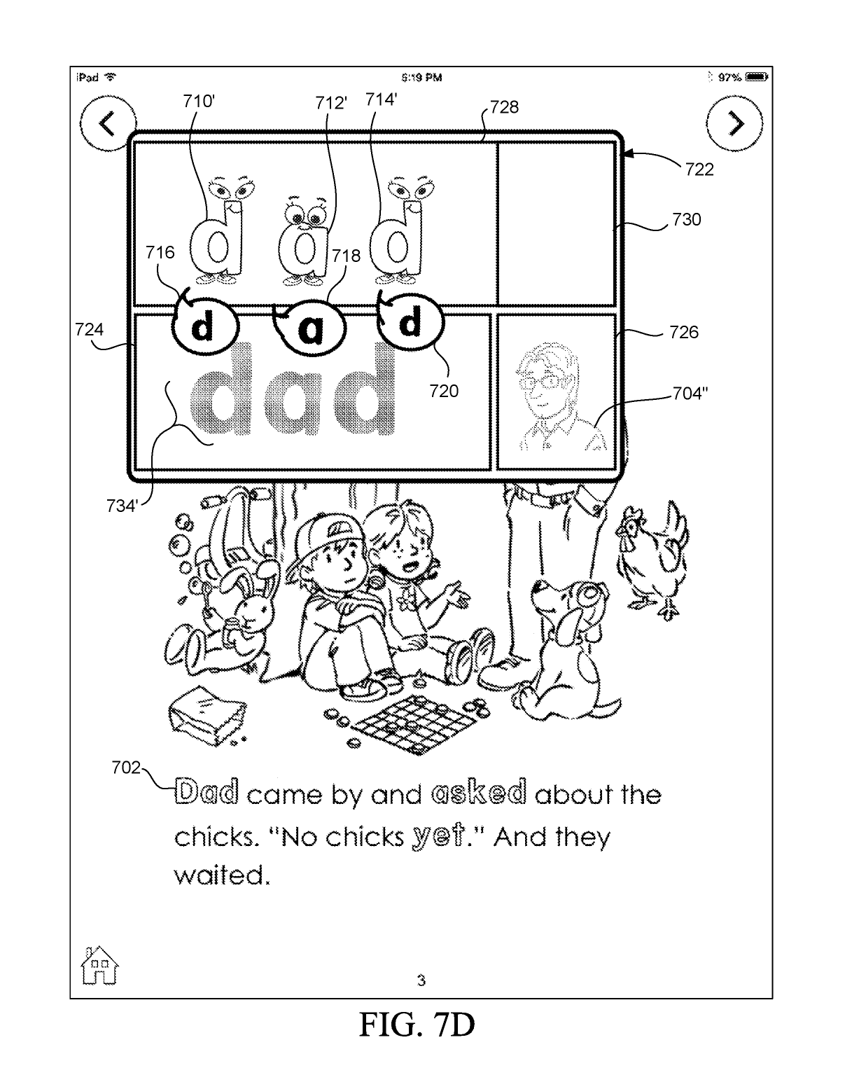

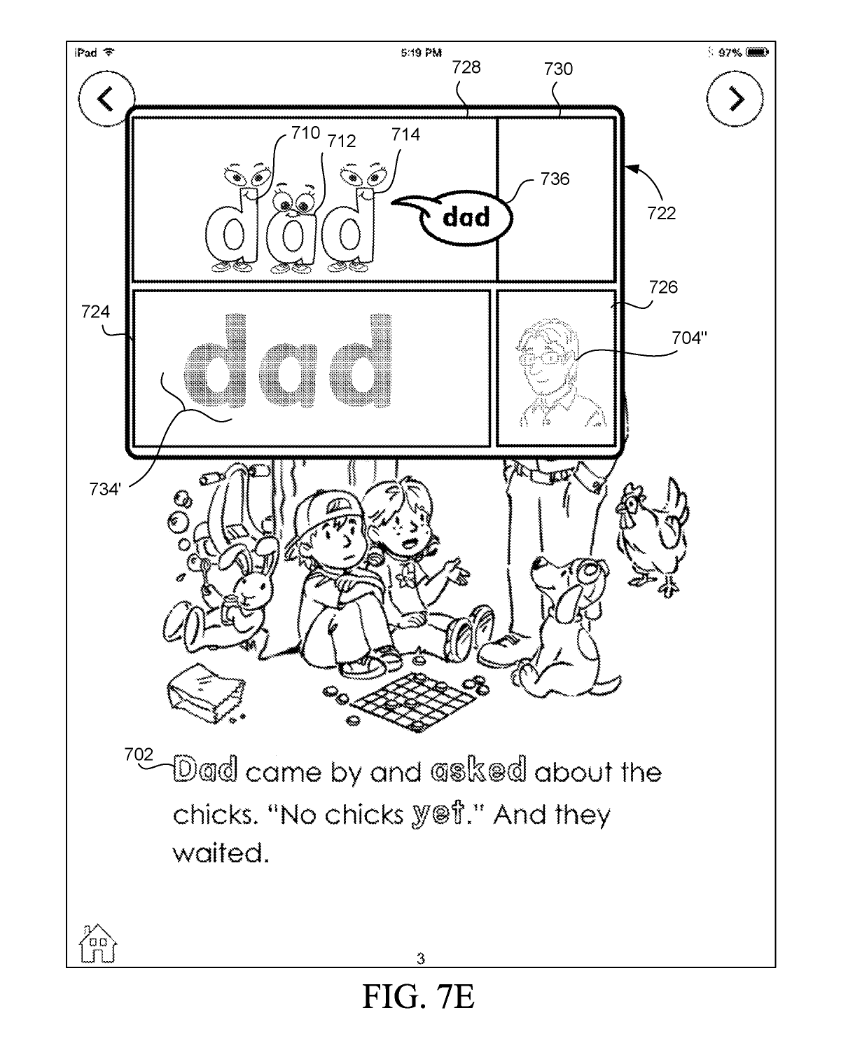

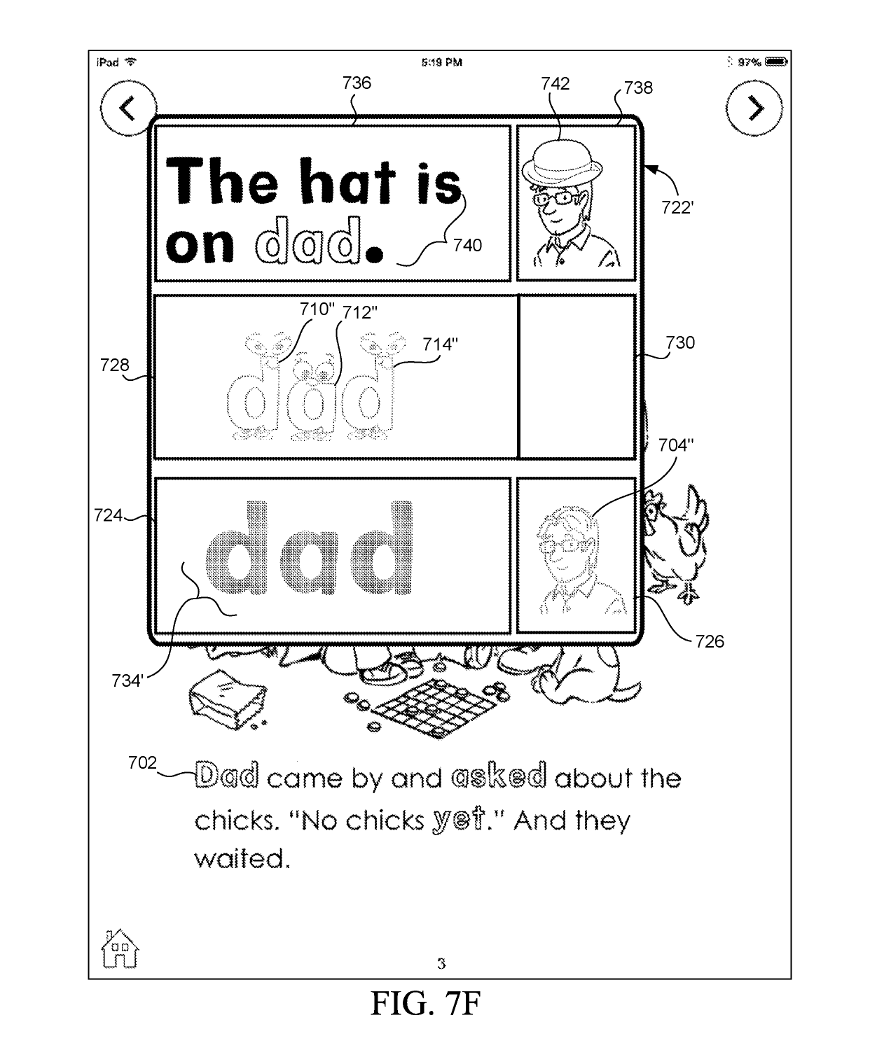

FIG. 6 is a flowchart showing certain salient steps of a process 600, according to another embodiment of the present teachings, for teaching pronunciation and/or spelling. Process 600 begins with a step 602, which includes causing to be displayed or displaying at a client device a visual representation of at least one selectable word and an illustration of an object associated with the selectable word. For example, FIG. 7A shows a screenshot that includes a selectable word 702, “Dad,” and shows the illustration of an associated object 704, which is an illustration of a dad.

Next, a step 604 includes receiving an instruction that the selectable word is selected by a user. For example, FIG. 7A shows a user icon 706 selecting selectable word 702, “Dad.”

Steps 602 and 604 are substantially similar to their counterparts in process 400 of FIG. 4, i.e., steps 402 and 404, respectively. In certain embodiments of the present teachings, however, the manner of selecting the selectable word in step 604 of FIG. 6 is different than manner of selecting the selectable word in step 404 of FIG. 4. For example, the story animation may be configured for a user to tap on a selectable word once to begin the language lesson associated with the embodiment of FIG. 4, or twice to begin the language lesson associated with the embodiment of FIG. 6. This provides the advantage of providing the user a choice between starting various language lessons based on the same selectable word.

Process 600 then proceeds to a step 606, which includes causing to be generated or generating at the client device, in response to the selection by the user, an animated sequence that includes providing: (i) one or more character representations for at least some letters present in the selectable word; (ii) an audible and/or a visual representation associated with each character representation; and (iii) a pronunciation of the selectable word. For example, FIG. 7C shows character representations 710, 712, and 714, which represent the letters “d,” “a,” and “d,” respectively, forming the word “dad.” FIG. 7D shows sound bubbles 716, 718, and 720 depicting audible representations of the phonetic sounds “d,” “a,” and “d,” respectively, emanating from character representations 710′, 712′, and 714′, respectively. Finally, FIG. 7E shows sound bubble 736, which depicts an audible representation, e.g., pronunciation, of the word “dad,” collectively emanating from character representations 710, 712, and 714.

Process 600 of FIG. 6 may include one or more additional steps to facilitate teaching pronunciation and/or spelling of a word. For example, process 600 may implement a step that includes causing to be generated or generating another animated sequence that includes providing a visual representation of: (i) the selectable word; and (ii) the object associated with the selectable word. According to one preferred embodiments of the present teachings, this animated sequence presents a grid that includes one or more rows and one or more columns such that the intersection of one of the rows with one of the columns defines a cell. A cell in the grid may be configured to receive the selectable word and/or an illustration of an object associated with the selectable word. A visual representation of the selectable word may be arranged inside a first cell and the visual representation of the object associated with the selectable word may be arranged inside the second cell. In one exemplar configuration, the first cell and the second cell are aligned along one row or one column. For example, in FIG. 7B, a textual representation 734 of the selectable word, “dad,” is disposed inside a first cell 724, and an illustration of an associated object 704′, which is an illustration of a dad, is shown disposed inside second cell 726. As shown in FIG. 7B, second cell 726 is aligned along a row with first cell 724.

Further, additional cells in the grid may be used to facilitate presentation of a language lesson. For example, a character representation for each letter present in the selectable word (i.e., shown in the first cell) may be presented in a third cell that is aligned with the first cell along a row or column. For example, FIG. 7C shows character representations 710, 712, and 714, which represent the letters “d,” “a,” and “d,” respectively, disposed in a third cell 728. As shown in FIG. 7C, third cell 728 is aligned in a column with first cell 724.

Further still, a fourth cell that is aligned with the first cell along a row or column may include a sentence describing the object. For example, fourth cell 736 shows a sentence 740, which states, “The hat is on dad.” As shown in FIG. 7F, fourth cell 736 is aligned in a column with first cell 724.

In a similar manner, an illustration of what is conveyed by the sentence in the fourth cell may be presented in a fifth cell, which may be aligned with the second cell along a row or column. For example, fifth cell 738 of FIG. 7F shows an illustration 742 depicting that the hat is on the dad. As shown in FIG. 7F, fifth cell 738 is aligned in a column with second cell 726.

In certain embodiments of the present teachings, process 600 includes the additional step of pronouncing the selectable word. Preferably, this additional step is carried out after step 604 and before step 606.

In a similar manner to that described above with reference to step 406 of FIG. 4, in step 606 of FIG. 6, the audible representation of each letter and/or the pronunciation of the selectable word may be accompanied by presentation of a character representation in a modified or changing state. For example, the character representations of letters in a selectable word may be depicted as spaced apart by a certain distance (i.e., such that each character representation of a letter appears as a spaced letter), and then, the character representation may be depicted as pronouncing the phonetic sound associated with each letter in a selectable word. For example, FIG. 7D shows character representation 710′, 712′, and 714′, representing the letters “d,” “a,” and “d,” respectively, each spaced apart by a certain distance from each other in third cell 728. Further, sound bubbles 716, 718, and 720 represent audible representations (not presented to the user, but presented in FIG. 7D to facilitate discussion), e.g., the phonetic sounds associated with the letters “d,” “a,” and “d,” respectively.

Then, the character representations of each letter may be moved and/or shown moving closer together (i.e., to give the appearance of a word instead of spaced letters), at which time the selectable word is pronounced, and preferably with the appearance that the character representations are pronouncing the selectable word. For example, FIG. 7E shows character representations 710, 712, and 714, representing the letters “d,” “a,” and “d,” respectively, each shown moved closer together, and a sound bubble 736 (not presented to the user, but shown in FIG. 7E to facilitate discussion) represents an audible representation (e.g., pronunciation) of the word “dad” emanating from character representations 710, 712, and 714.

FIGS. 7A-7F show a series of screenshots from story illustrations and/or an animated sequence that teach pronunciation and/or spelling, according to another embodiment of the present teachings. All of these figures have been described above with reference to process 600 of FIG. 6.

FIG. 7A is a screenshot that shows a selectable word being selected by a user. FIG. 7A also shows a selectable word 702, “Dad,” an object 704, which is depicted as an illustration of the dad associated with selectable word 702 in the context of a story illustration, and a user icon 706 in the form of a stylized hand selecting selectable word 702 by touching a touchscreen display at that location. Selectable word 702, object 704, and user icon 706 are substantially similar to their counterparts in FIG. 5B, i.e., selectable word 502, object 704, and user icon 706.

After selection of a selectable word is made as shown in FIG. 7A, and an instruction is received by the server and/or client device that the selectable word has been selected, and the illustration progresses to FIG. 7B. FIG. 7B is a screenshot that shows an animated sequence that begins with an animated grid being superimposed over the story illustration presented in FIG. 7A.

The screenshot presented in FIG. 7B includes selectable word 702 and an object 704′, which is substantially similar to its counterpart in FIG. 7A, object 704, but is now shown as an illustration disposed in a grid cell (described in further detail below). FIG. 7B also includes a grid 722 with a first cell 724, a second cell 726, a third cell 728, and a fourth cell 730. Textual representation 734 of the word “dad” is disposed in first cell 724, object 704′ is disposed in second cell 726, and third cell 728 and fourth cell 730 are empty. Sound bubble 736 is presented to convey that an audible representation (e.g., pronunciation) of the word “dad” emanates from selectable word 734.

Next, the screenshot presented in FIG. 7C includes an object 704″ and a textual representation 734′, both with a changed appearance (i.e., drawn with dotted lines) from those of object 704′ and textual representation 734, respectively, in FIG. 7B. These changed appearances indicate that the word (“dad”) associated with the object (a picture of the dad) has been pronounced (as shown in sound bubble 736 of FIG. 7B). In certain embodiments of the present teachings, textual representation 734′ and object 704″ disappear, and are therefore not shown in grid 722 after the word “dad” has been pronounced.

FIG. 7B also shows, in third cell 728, a character representation 710 of the letter “d,” a character representation 712 of the letter “a,” and a character representation 714 of the letter “d” (i.e., the letters that form the word “dad”). As shown in FIG. 7C, character representations 710, 712, and 714 are shown close enough to give the appearance of representing the word “dad.” In certain embodiments of the present teachings, these character representations do not stay stationary, but may demonstrate movement or changed appearance, such as growing and/or shrinking slightly, or looking in different directions.

Next, the screenshot presented in FIG. 7D shows, in third cell 728, a character representation 710′, a character representation 712′, and a character representation 714′, which are substantially similar to their counterparts described above with reference to FIG. 7C, i.e., character representations 710, 712, and 714, respectively. Unlike character representations 710, 712, and 714 in FIG. 7C, however, character representations 710′, 712′, and 714′ are shown spaced a certain distance apart so as to convey to the user separate phonetic sounds associated with each letter of the word “dad.” To facilitate this, FIG. 7D also shows a sound bubble 716 to convey the sound for “d” emanating from character representation 710′, a sound bubble 718 to convey the sound for “a” emanating from character representation 712′, and a sound bubble 720 to convey the sound for “d” emanating from character representation 714′. In other words, the character representations for the word “dad” are spaced a certain distance apart, and are then programmed to sequentially generate phonetic sounds associated with each of letters “d,” “a,” and “d.”

Next, the screenshot presented in FIG. 7E shows a sound bubble 736 to convey the sound for the word “dad,” indicating pronunciation of the word “dad” emanating from the character representations (that produce the word “dad”) in third cell 728. In other words, unlike in FIG. 7D, where character representations 710′, 712′, and 714′ are spaced a certain distance apart to reflect pronunciation of the separate phonetic sound associated with each letter, FIG. 7E shows character representations 710, 712, 714 placed closer together to reflect pronunciation of the entire word “dad.”

Next, the screenshot presented in FIG. 7F shows a character representation 710″, a character representation 712″, and a character representation 714″, which are substantially similar to their counterparts in FIG. 7E, i.e., character representation 710, character representation 712, and character representation 714, respectively, though the appearances of the character representations in FIG. 7F are shown as changed (i.e., drawn with dotted lines) to indicate that the word “dad” was previously pronounced. In other embodiments of the present teachings, however, third cell 728 appears empty after the word “dad” has been pronounced.

FIG. 7F also shows a grid 722′, which is substantially similar to its counterpart in FIG. 7E, i.e., grid 722, except grid 722′ also includes disposed on a top end a fifth cell 736 and a sixth cell 738. Disposed inside fifth cell 736 is a sentence 740, which incorporates the word “dad” in the context of a sentence, “The hat is on the dad.” Disposed inside sixth cell 738 is an illustration 742 depicting what is described in sentence 740, i.e., that the hat is on the dad. In other words, FIG. 7F builds upon the pronunciation of the word “dad,” as shown with respect to sound bubble 736 of FIG. 7E, by presenting the word “dad” in a sentence (as shown in fifth cell 736) and by illustrating a depiction of the sentence (as shown in sixth cell 738).

In certain embodiments of the present teachings, while the screenshot of FIG. 7E is presented to a user, an audio clip, which may be part of pronunciation module 388 of FIG. 3A is used to repeat pronunciation of the word “dad” (e.g., emanating from character representations 710″, 712″, and/or 714″) and/or to pronounce the sentence shown in fifth cell 736. Such actions serve to reinforce or build upon earlier-presented lessons taught to the user.

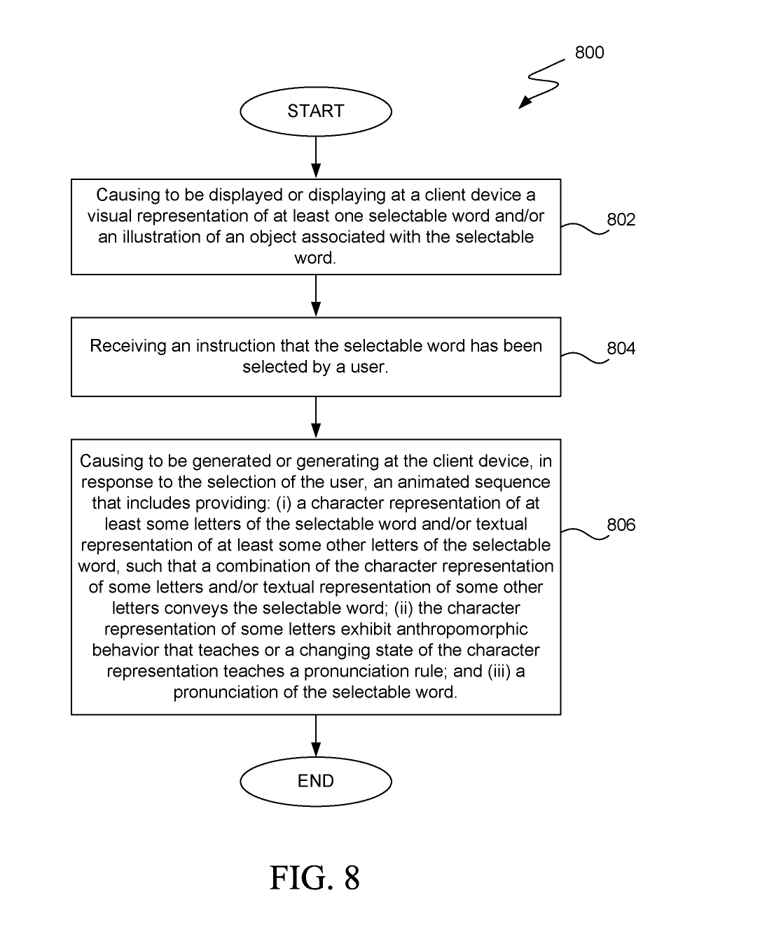

FIG. 8 is a flowchart showing certain salient steps of a process 800 for teaching pronunciation and/or a pronunciation rule. FIG. 8 begins with a step 802, which includes causing to be displayed or displaying at a client device a visual representation of at least one selectable word and an illustration of an object associated with the selectable word. Next, a step 804 includes receiving an instruction that the selectable word is selected by a user.

Step 802 and step 804 are substantially similar to their counterparts described above in FIG. 6, i.e., step 602 and step 604, respectively. Steps 802 and 804 may be thought of as the steps practiced to begin a language lesson, from an illustrated story, that teaches one or more pronunciation rules to a user. In certain embodiments of the present teachings, however, a user may begin a language lesson that teaches one or more pronunciation rules separately from a story (e.g., in a stand-alone fashion or from a “dictionary” listing from which the user selects or is presented a word that is used to teach pronunciation and/or one or more pronunciation rules).

Next, a step 806 includes causing to be generated or generating at the client device, in response to the selection of the user, a first animated sequence that includes providing: (i) a character representation of at least some letters of the selectable word and/or textual representation of at least some other letters of the selectable word (ii) the character representation of some other letters exhibit anthropomorphic behavior or a changing state of the character representation teaches a pronunciation rule; and (iii) a pronunciation of the selectable word. In the first animated sequence, the combination of the character representation of some letters and/or textual representation of some other letters conveys the selectable word.

A pronunciation rule is any rule that governs how one or more letters are used to produce an associated sound within the context of a word. According to one embodiment of the present teachings, teaching a pronunciation rule includes at least one rule selected from a group comprising (i) teaching pronunciation of a combination of letters that produce a single sound when the selectable word is pronounced; (ii) teaching pronunciation of a selectable word that includes one more silent letters; and (iii) teaching pronunciation of a selectable word that is a sight word. The present teachings recognize, however, that any pronunciation rule is capable of being taught using the systems and methods disclosed herein.

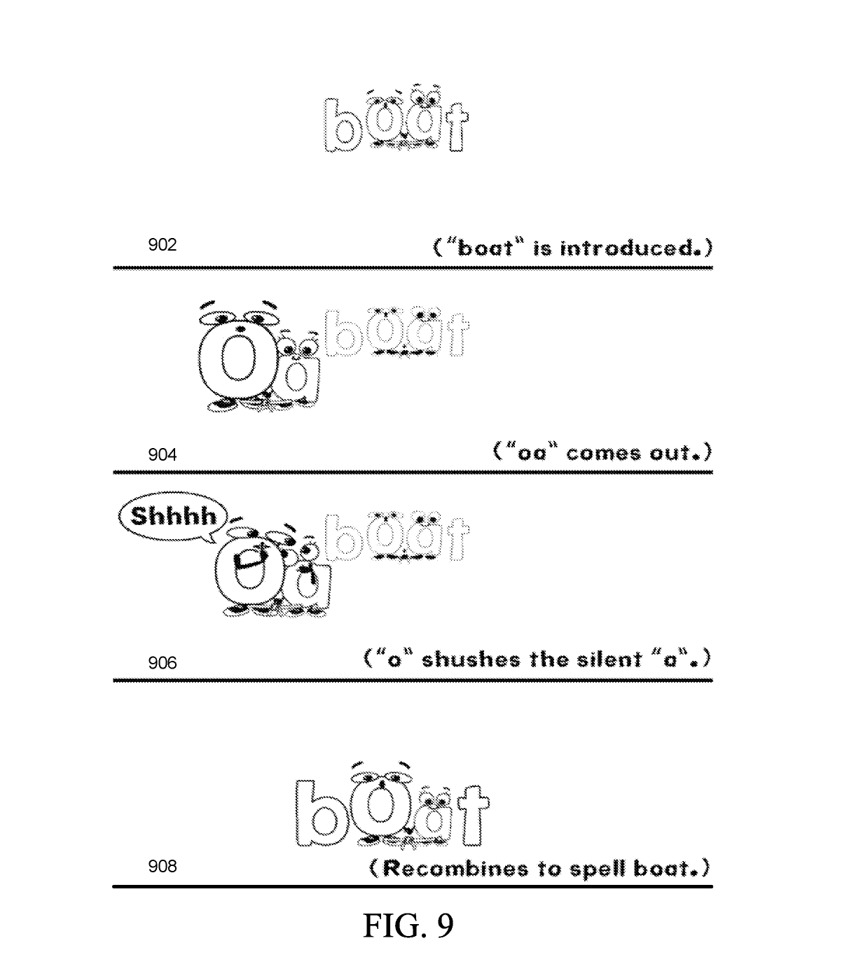

The following figures (i.e., FIGS. 9, 10A-10C, 11A-11D, 12A-12D, and 13A-13D), illustrate clips of animated sequence that may be shown on a client device's display screen (e.g., a touchscreen) at sequential times after a selectable word that is selected to teach how a selectable word is pronounced and/or one or more pronunciation rules associated with pronunciation of the selectable word. The animated sequence may take place over several seconds, with the following figures being snapshots or clips of the animated sequence. The character representations of letters may appear to move, in particular to draw attention according to their pronunciation.

FIG. 9 shows a series of four frames from an animated sequence used to teach a pronunciation rule, according to one embodiment of the present teachings. In particular, FIG. 9 is used to teach a user the pronunciation rule that when pronouncing the word “boat,” the “a” is silent. It will be clear to one skilled in the art that variations on these teachings could be used to provide animations teaching the pronunciation and/or pronunciation rule(s) of any word in English, or in any other language. Further, the following animations could be presented in a stand-alone fashion, as in a dictionary listing, or be animated along with an object, as described above.

In FIG. 9, a frame 902 is used to introduce the word “boat,” preferably after having been selected by a user. As shown in frame 902, the “o” and the “a” are presented as joined character representations. This emphasizes to the user that the pronunciation rule being taught relates to these letters together. The “b” and the “t,” which are not implicated by a pronunciation rule being taught in FIG. 9, are presented as textual representations.

Next, a frame 904 shows the character representations of the “o” and the “a” separated and/or separating from the textual representations of the “b” and the “t.” Once separated, the character representation of the “o” is also shown as growing or having grown larger than “a,” which suggests to the user that the “o” sound is emphasized when pronouncing “boat.” The remaining character representations are deemphasized by being drawn with dotted lines.

Next, a frame 906 shows that the character representation of the “o” shushes, or silences, the “a,” as shown by the sound bubble depicting the audible representation of “Shhhh.” This suggests to the user that the “a” will be silent when “boat” is pronounced, and that the “a” is silenced by the presence of the “o” before it. Likewise, frame 906 also depicts the character representations of the “o” and “a” looking at each other, with the character representation of the “o” making a “shushing” gesture towards the character representation of the “a.”

Next, a frame 908 shows that the character representations of the “o” and the “a” have recombined with the textual representations of the “b” and the “t” to form the word “boat.” Unlike the depiction in frame 902, however, the character representation of the “o” is shown a much larger than the character representation of the “a,” indicating to the user that the “o” sound will be stressed in pronouncing the word “boat.” Then, as shown by the sound bubble conveying the pronunciation of the word “boat,” accordingly, the word “boat” is then pronounced in an audio clip.

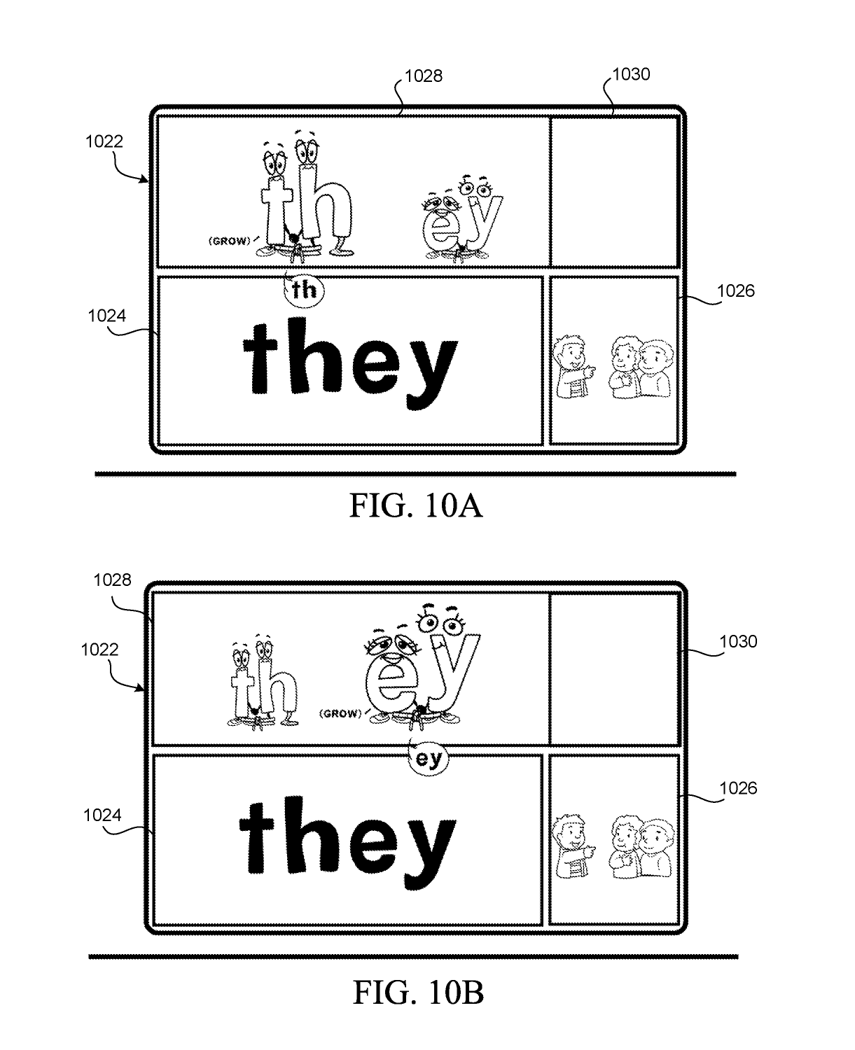

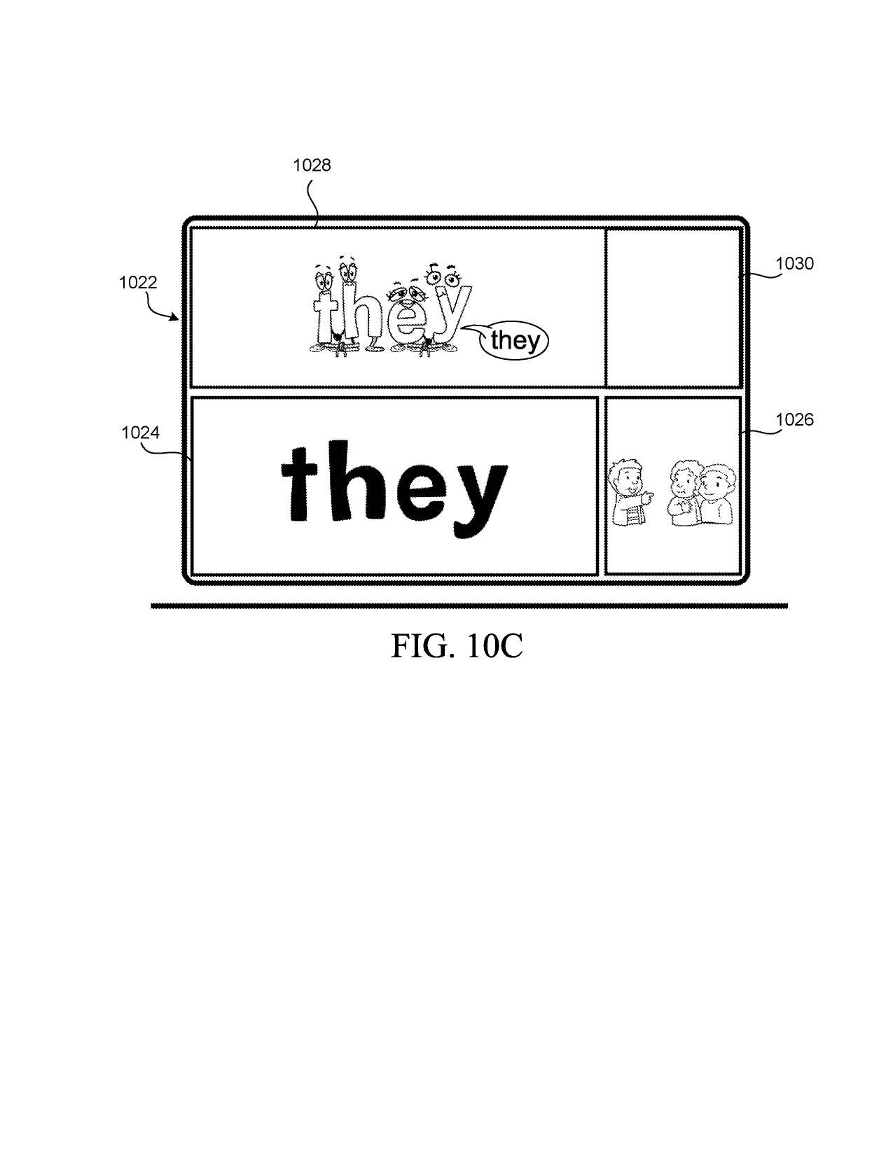

FIGS. 10A-10C show a series of animated sequence clips from a language lesson that teaches pronunciation rules associated with pronunciation of the word “they.” Unlike the embodiment of FIG. 9, the embodiment of FIG. 10 uses an animated sequence that incorporates a 2×2 grid to teach pronunciation and/or pronunciation rules. To this end, each of FIGS. 10A-10C includes a grid 1022 that has a first cell 1024, a second cell 1026, a third cell 1028, and a fourth cell 1030.

FIG. 10A shows an animated sequence clip that may be presented after the word “they” has been selected by a user, preferably in the context of an illustrated or animated story. A textual representation of the word “they” is disposed inside first cell 1024, indicating to the user that pronunciation of and/or pronunciation rules associated with the word “they” will be taught. An illustration of one child pointing to two other children is shown disposed in second cell 1026, conveying to the user the meaning of the word “they.”

In third cell 1028, character representations of “t” and “h” are shown tied together, or joined, and separated from the character representations of “e” and “y,” which are also shown tied together, or joined. Tying these letters together and then separating the combined letters from each other teaches the user that each of the letter combinations produces a separate phonetic sound when “they” is pronounced. Further, as shown in the parenthetical “(GROW),” the “th” is shown growing or having grown while a “th” is pronounced, as depicted in the sound bubble. As shown in FIG. 10A (as well as in subsequent figures), words presented in a parenthetical denote a character representation action observed in the animated sequence by the user, though the parenthetical itself is not visible to the user.

In FIG. 10B, third cell 1028 now shows the joined character representations of “th” no longer grown, while the joined character representations of “ey,” as shown by the parenthetical “(GROW),” are depicted as grown or growing. A sound bubble conveying the phonetic sound associated with the letter combination “ey” is pronounced by an audio clip while the character representations of “ey” are shown as grown or growing.

In FIG. 10C, third cell 1028 presents all of the character representations joined or joining together to form the word “they.” At the same time, a sound bubble conveys the pronunciation of the word “they.” Thus, the user is taught pronunciation of the word “they,” and the pronunciation rules that “th” join together to make a single sound, and that “ey” join together to make a single sound.

Fourth cell 1030 is left blank in FIGS. 10A-10C. To the extent a cell shown in the figures presented herein is shown as blank, it may be used in any manner necessary to facilitate teaching of a language lesson. As one example, fourth cell 1030 may include an icon that may be clicked to end the language lesson and return to a story. As another example, fourth cell 1030 may include an icon that may be clicked to begin a writing lesson involving the word “they.”

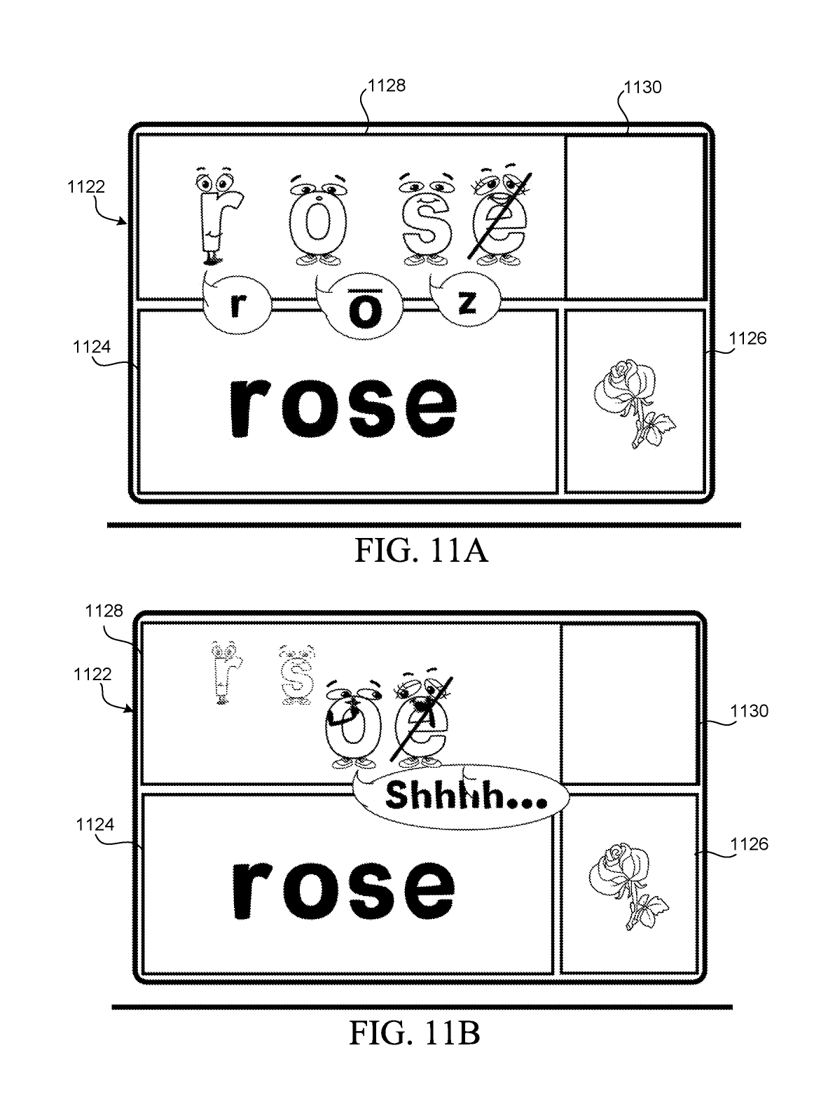

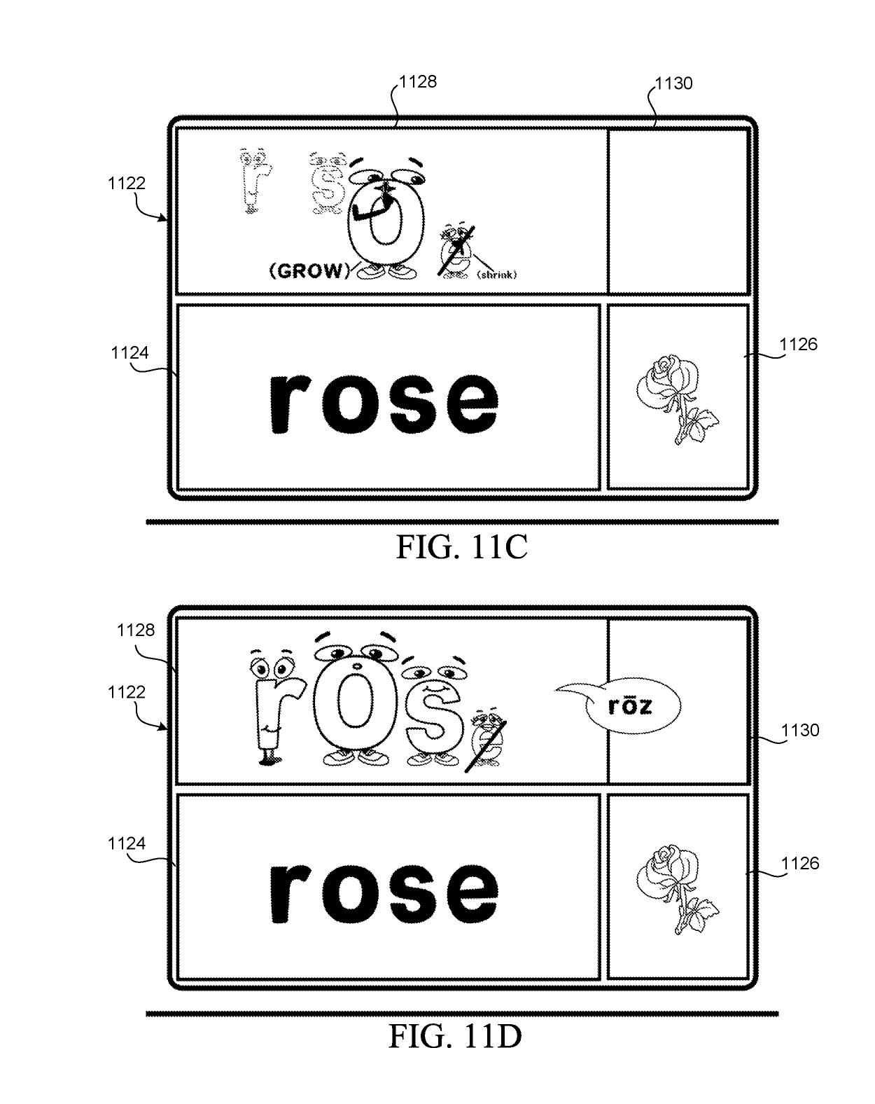

FIGS. 11A-11D show a series of animated sequence clips from a language lesson that teaches pronunciation rules associated with and/or pronunciation of the word “rose.” Each of FIGS. 11A-11D show a grid 1122 that includes a first cell 1124, a second cell 1126, a third cell 1128, and a fourth cell 1130.

FIG. 11A shows an animated sequence clip that may be presented when a user selects the word “rose.” A textual representation of the word “rose” is disposed in first cell 1124, and an illustration of a rose is disposed in second cell 1126.

Third cell 1128 includes a character representation of “r” disposed a certain distance from a character representation of “o,” which is disposed a certain distance from a character representation of the joined letters “se.” These indicate that three separate phonetic sounds, “r,” “ō,” and “se,” are made when pronouncing the word “rose.” To this end, sound bubbles convey the phonetic sounds emanating, respectively, from the character representations of “r,” “o,” and “se,” respectively. Further, the character representation of “e” is shown as crossed out, indicating to the user that the pronunciation rule that “e” is silent when “rose” is pronounced.

In FIG. 11B, third cell 1028 presents the character representations of the “o” and the “e” separated from the character representations of the “r” and the “s.” The character representations of the “r” and the “s” are shown drawn with dots to indicate that their pronunciation is not emphasized in FIG. 11B. The character representation of the “o” is shown shushing or silencing the character representation of “e” (which is still crossed out), as indicated by the sound bubble conveying the sound associated with “Shhhh . . . ” These teach the user the pronunciation rule that it is the presence of the “o” in the word “rose” that causes the “e” to be silent when the word “rose” is pronounced. In other words, the “o” silences the “e.”

In FIG. 11C, third cell 1128 shows that the character representation of “o” is grown or growing, as indicated by the parenthetical “(GROW),” while the character representation of “e” is shown as smaller or shrinking, as indicated by the parenthetical “(shrink).” These growing and shrinking actions convey to the user the pronunciation rule that the “o” is pronounced and the “e” is silent when the word “rose” is pronounced.

Next, in FIG. 11D, third cell 1128 presents the character representations of “r,” “o,” “s,” and “e” as joined together to form the word “rose.” Further, relative to the sizes of the character representations of “r” and “s,” the character representation of “o” maintains its larger size from the previous animated sequence clip in FIG. 11C, and the character representation of the letter “e” (which remains crossed out) maintains its smaller size from the previous animated sequence clip in FIG. 11C. This teaches the user that in pronouncing the word “rose,” the “o” is emphasized and the “e” is silent. To this end, FIG. 11D also shows a sound bubble conveying pronunciation of the word “rose.”

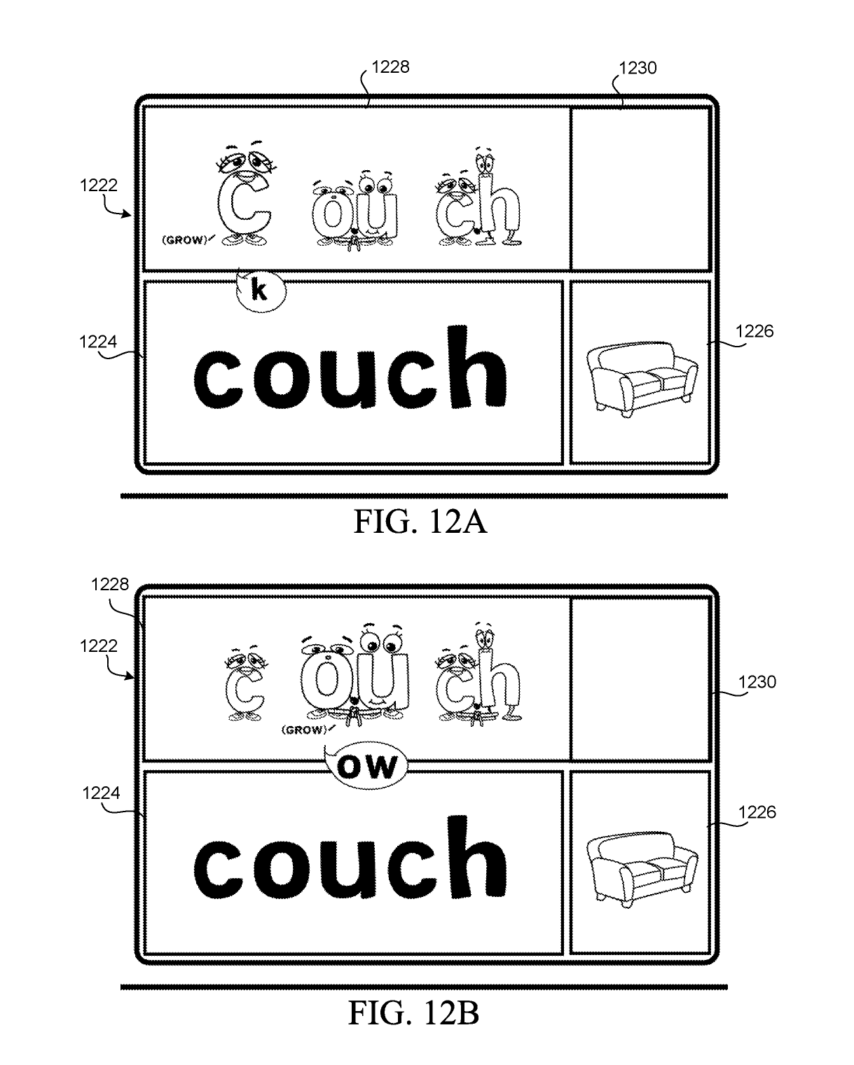

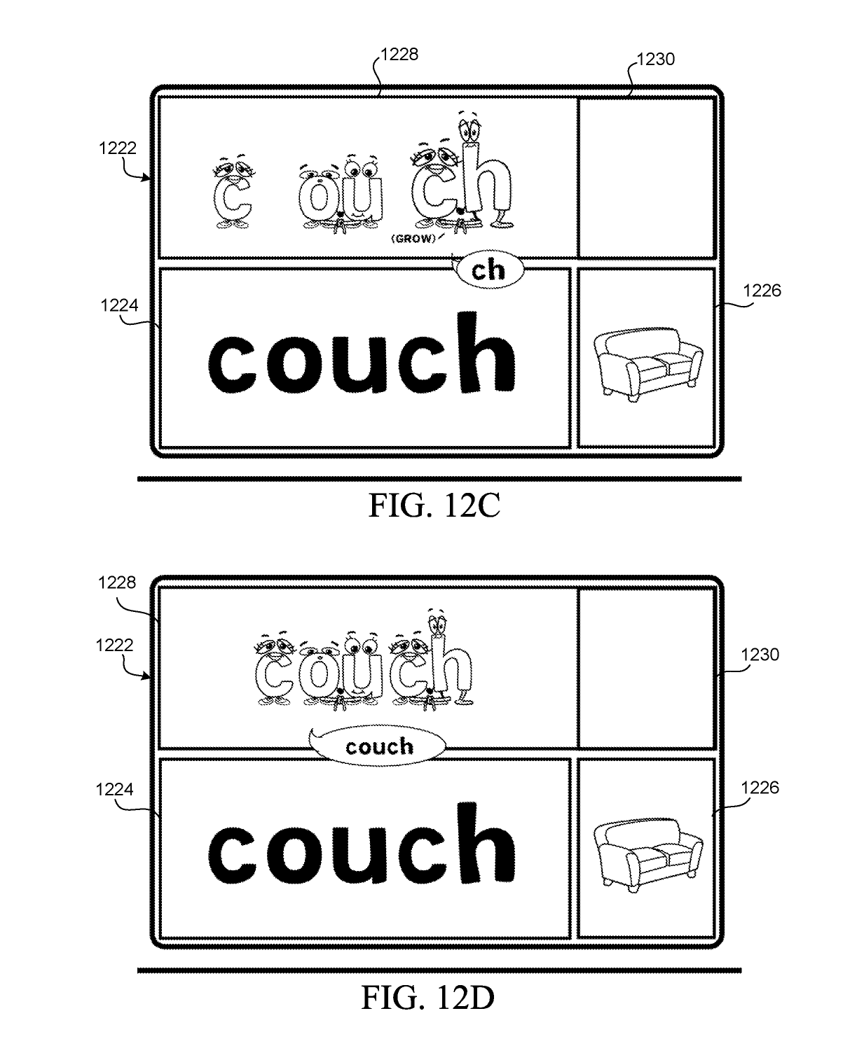

FIGS. 12A-12D show a series of animated sequence clips from a language lesson that teaches pronunciation rules associated with and/or pronunciation of the word “couch.” Each of FIGS. 12A-12D show a grid 1222 that includes a first cell 1224, a second cell 1226, a third cell 1228, and a fourth cell 1230.

FIG. 12A shows an animated sequence clip that may be presented when a user selects the word “couch” (e.g., within the context of an illustrated story presented on a client device). A textual representation of the word “couch” is disposed in first cell 1224, and an illustration of a couch is disposed in second cell 1226.

Third cell 1228 includes a character representation of “c” disposed a certain distance from character representations of “ou” joined together, which is disposed a certain distance from character representations of “ch” joined together. The joining together of the character representations of “o” and “u,” and the joining together of the character representations of “c” and “h,” indicate to the user that each of these combinations produces a single sound when the word “couch” is pronounced. Further, the separate placements, a certain distance apart, of “c,” “ou,” and “ch” in third cell 1228 indicate that three separate phonetic sounds, “c,” “ou,” and “ch” are produced when pronouncing the word “couch.”

As shown in third cell 1228, the character representation of “c” is shown as grown or growing, as indicated by the parenthetical “(GROW).” This grown or growing state of “c” is associated with pronunciation of “c,” which is indicated by the sound bubble conveying the phonetic sound associated with “k.”

In FIG. 12B, the character representation of “c” has been reduced to the same approximate size as the character representation of “ch” in third cell 1228. The character representations of “ou,” on the other hand, are shown as grown or growing, as indicated by the parenthetical “(GROW).” This growth of the character representations of “ou” is associated with pronunciation of “ou” from the word “couch,” which is indicated by the sound bubble conveying the phonetic sound associated with the letter combination “ow” shown in FIG. 12B. In other words, the user is taught the pronunciation rule that the “ou” in couch is pronounced phonetically as “ow.”

In FIG. 12C, third cell 1228 presents the character representation of “ou” reduced to the same size as the character representation of “c,” while the character representation of “ch” is shown as grown of growing, as indicated by the parenthetical “(GROW).” This grown or growing state of the character representation of “ch” is associated with pronunciation of the sound “ch” from the word couch,” as indicated by the sound bubble conveying the phonetic sounds associated with the letter combination “ch.” In other words, the user is taught the pronunciation rule that when pronounced, the combination of the letters “c” and “h” produce the phonetic sound “ch” when the word “couch” is pronounced.

Next, in FIG. 12D, third cell 1228 presents the character representations of each of “c,” “ou,” and “ch” as the same size and joined together to form the word “couch.” Further, pronunciation of the word “couch” is presented, as indicated by the presence of a sound bubble depicting audible representation of “couch.” Thus, FIGS. 12A-12D progressively teach pronunciation of “c” (shown in FIG. 12A), “ou” (shown in FIG. 12B), “ch” (shown in FIG. 12C), and the complete word, “couch” (shown in FIG. 12D).

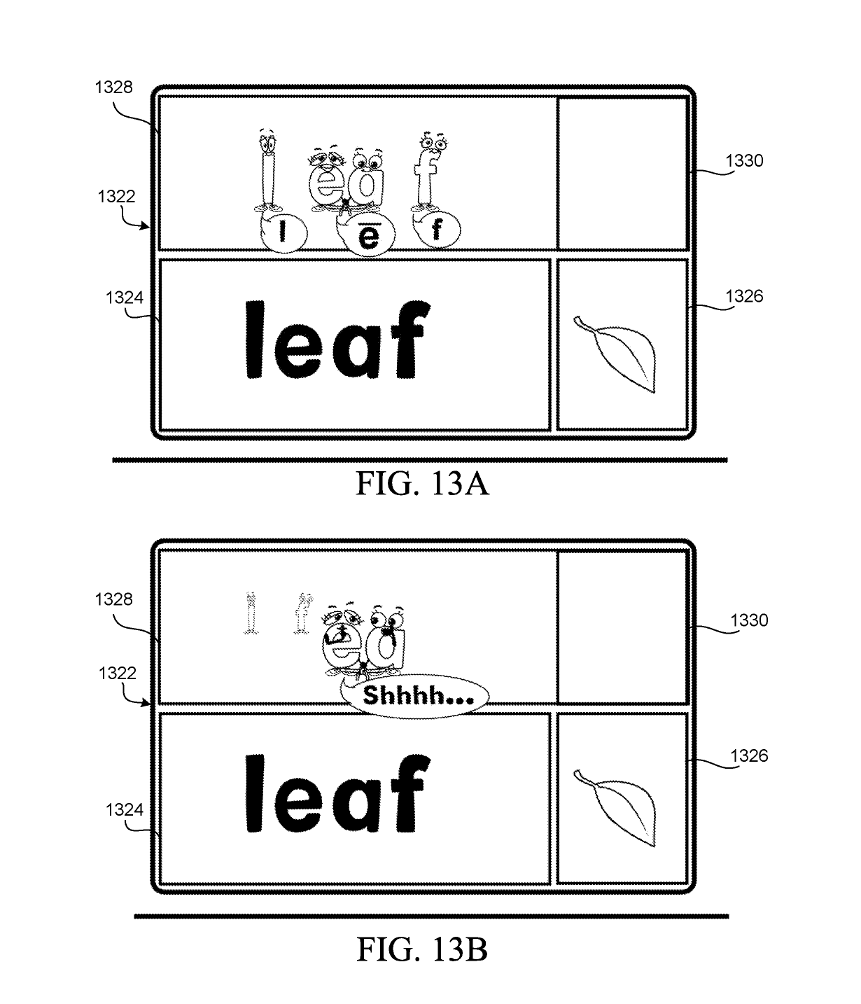

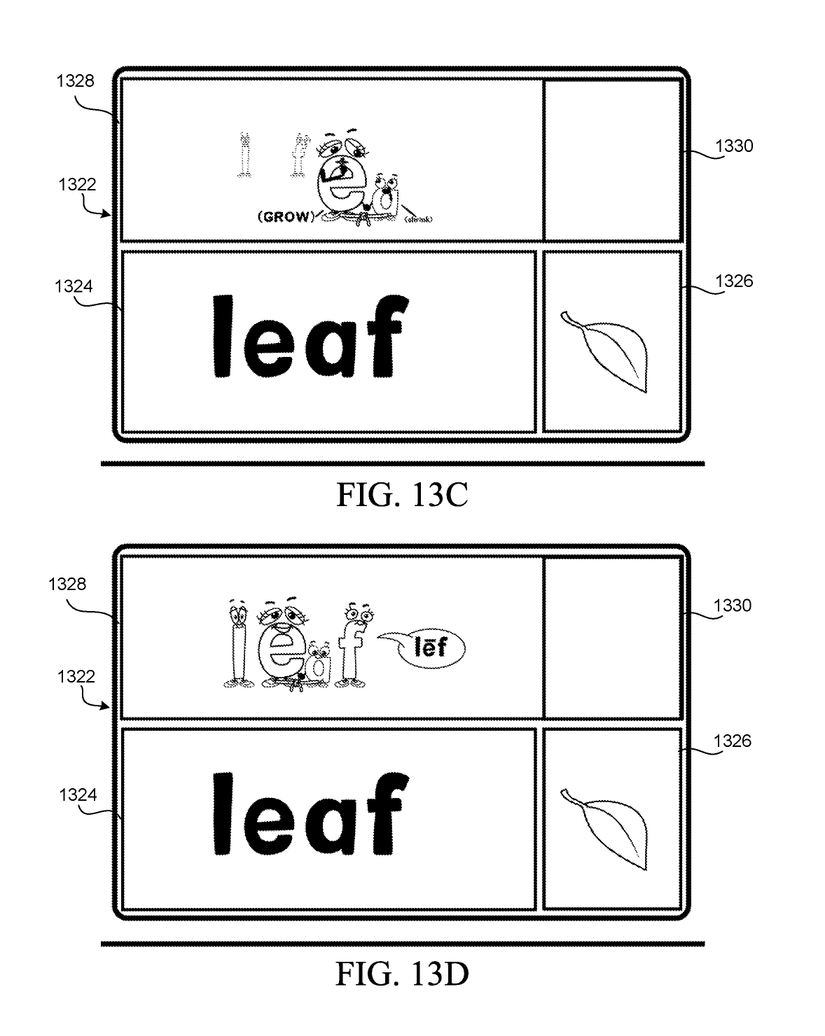

FIGS. 13A-13D show a series of animated sequence clips from a language lesson that teaches pronunciation rules associated with and/or pronunciation of the word “leaf,” according to one embodiment of the present teachings. Each of FIGS. 13A-13D show a grid 1322 that includes a first cell 1324, a second cell 1326, a third cell 1328, and a fourth cell 1330.

FIG. 13A shows an animated sequence clip that may be presented when a user selects the word “leaf.” A textual representation of the word “leaf” is disposed in first cell 1324, and an illustration of a leaf is disposed in second cell 1326.

Third cell 1328 includes a character representation of an “l” disposed a certain distance from character representations of “eu” joined together, which is disposed a certain distance from a character representation of “f.” The joining together of the character representations of “e” and “a” indicate to the user that this combinations produces a single sound when the word “leaf” is pronounced. Further, the separate placements of “l,” “ea,” and “f” in third cell 1328 indicates that three separate sounds, “l,” “ea,” and “f” are produced when pronouncing the word “leaf.” To this end, third cell 1328 also shows a sound bubble conveying the phonetic sound associated with “l” emanating from the character representation of “l,” a sound bubble conveying the phonetic sound associated with “ē” emanating from the character representation of “ea,” and a sound bubble conveying the phonetic sound associated with f” emanating from the character representation of “f.”

In FIG. 13B, third cell 1328 presents the joined character representation of “ea” are shown separated from the character representations of “l” and “f,” which are deemphasized in third cell 1328 by being drawn with dotted lines. Further, the “e” in the joined character representations of “ea” is shown gesturing to the character representation of “a,” and is “shushing” the character representation of “a,” as indicated by the sound bubble conveying the phonetic sound associated with “Shhhh . . . ” This indicates to the user than when the word “leaf” will be pronounced, the “a” will be silent.

In FIG. 13C, third cell 1328 presents the character representation of “e” as grown or growing relative to the character representation of “a,” which is shown shrunk or shrinking. These changing states are further indicated by the parentheticals “(“GROW”) and (“SHRINK”) presented in third cell 1328. These growing states serve to re-emphasize to the user the pronunciation rule that pronunciation of “e” is dominant over the pronunciation of “a,” which is silent.

Next, in FIG. 13D, third cell 1328 presents the character representation of “l,” “e,” “a,” and “f” as joined together to form the word “leaf.” Further, a sound bubble conveying the phonetic sound associated with “lēf” is shown, indicating, for example, that Teaching Platform 100 has delivered an audio clip of the word “leaf” being pronounced. In such manner, a child is taught the pronunciation of the word leaf.

One embodiment of each of the examples described herein is in the form of an electronic device programmed to provide animation, and optionally audio, as displayed on an electronic device. Thus, as will be appreciated by those skilled in the art, embodiments of the present invention may be embodied as a device, a method, or a carrier medium, e.g., a computer program product. The carrier medium may carry one or more computer-readable code segments for controlling a processing system to implement a method. Accordingly, aspects of the present arrangements and teaching may take the form of a method, an entirely hardware embodiment, an entirely software embodiment, or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

In one preferred embodiment of the present arrangements, all modules required to carry out the present teachings, including but not limited to pronunciation module 388 and illustration/animation module 389 of FIG. 3A, are located on a client device.

Although illustrative embodiments of the present teachings have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method for teaching pronunciation, said method comprising:
causing to be displayed or displaying at a client device a visual representation of at least one selectable word and an illustration of an object associated with said selectable word, and wherein said selectable word includes one or more letters;
receiving an instruction that said selectable word is selected by a user; and
causing to be generated or generating at said client device, in response to a selection by said user in said receiving, an animated sequence that includes providing: (i) at a first location proximate to said illustration of said object, a character representation of each said letter present in said selectable word; (ii) an audible representation of each said letter present in said selectable word; and (iii) at a second location proximate to said illustration of said object, a visual representation of said selectable word and a pronunciation of said selectable word.

2. The method for teaching pronunciation of claim 1, further comprising causing to be displayed or displaying, at said client device, an indication that said selectable word is selected, wherein said indication includes an animation that depicts an illustration of a human hand tapping on said selectable word, and wherein said causing to be displayed or said displaying said indication is carried out after said causing to be displayed or said displaying of said visual representation of said selectable word.

3. The method for teaching pronunciation of claim 1, wherein said visual representation of said selectable word and said illustration of said object associated with said selectable word are part of an illustration of a story and/or a scene.

4. The method for teaching pronunciation of claim 1, wherein said receiving is carried out using a server and/or said client device.

5. The method for teaching pronunciation of claim 1, wherein in said causing to be generated or said generating said animated sequence, each of said character representations embodies a unique depiction of each letter, present in said selectable word, and includes one or more anthropomorphic features.

6. The method for teaching pronunciation claim 1, wherein in said causing to be generated or said generating said animated sequence, said audible representation of each said letter includes a pronunciation of a name of each said letter and/or a phonetic pronunciation of a sound associated with each said letter.

7. The method for teaching pronunciation claim 1, wherein in said causing to be generated or said generating said animated sequence, said audible representation of each said letter and/or said pronunciation of said selectable word is accompanied by a depiction of said character representation in a modified state.

8. The method for teaching pronunciation claim 1, wherein said modified state includes at least one state chosen from a group comprising shaking, shrinking, expanding, condensing, enlarging, turning, changing color, speaking, looking, and moving.

9. The method for teaching pronunciation claim 1, wherein said first location and said second location are the same.

10. A method for teaching pronunciation, said method comprising:
causing to be displayed or displaying at a client device a visual representation of at least one selectable word and an illustration of an object associated with said selectable word, and wherein said selectable word includes one or more letters;
receiving an instruction that said selectable word has been selected by a user;
causing to be generated or generating at said client device, in response to a selection by said user in said receiving, an animated sequence that includes providing: (i) one or more character representations for at least some letters present in said selectable word; (ii) an audible and/or a visual representation associated with each said character representation; and (iii) a pronunciation of said selectable word.

11. The method for teaching pronunciation of claim 10, further comprising causing to be displayed or displaying, at said client device, an indication that said selectable word is selected, wherein said indication includes an animation that depicts an illustration of a human hand tapping on said selectable word twice, and wherein said causing to be displayed or said displaying said indication is carried out after said causing to be displayed or said displaying of said visual representation of said selectable word.

12. The method for teaching pronunciation of claim 10, wherein in said causing to be generated or said generating said animated sequence, said audible representation of each said letter and/or said pronunciation of said selectable word is accompanied by said visual representation that includes depiction of said character representation in a modified state, and wherein said modified state includes at least one state chosen from a group comprising shaking, shrinking, expanding, condensing, enlarging, turning, changing color, speaking and moving.

13. The method for teaching pronunciation of claim 10, wherein in said causing to be generated or said generating said animated sequence, said audible and/or said visual representation associated with each said character representation further includes: (i) depicting each of said character representations being spread out from each other by a certain distance; (ii) providing a phonetic pronunciation for each said letter associated with said character representation, as said character representations remain spread out by said certain distance; (iii) depicting each of said character representations as no longer being spread out by said certain distance; and (iv) pronouncing said selectable word.

14. The method for teaching pronunciation of claim 10, further comprising:
causing to be generated or generating at said client device, in response to selection of said user in said receiving, another animated sequence that includes providing a visual representation of: (i) said selectable word; and (ii) said object associated with said selectable word;
pronouncing said selectable word; and
wherein said causing to be generated or generating said another animated sequence and said pronouncing are carried out after said receiving and before said causing to be generated or generating said animated sequence.

15. The method for teaching pronunciation of claim 14, wherein said causing to be generated or generating said animated sequence includes presenting, at said client device, a grid that includes one or more rows and one or more columns and an intersection of one of said rows with one of said column defines a cell, which is configured to receive said selectable word or said illustration of an object associated with said selectable word; and wherein said visual representation of said selectable word is arranged inside a first cell and said visual representation of said object associated with said selectable word is arranged inside said second cell, and wherein said first cell and said second cell are aligned along one of said rows or along one of said columns.

16. The method for teaching pronunciation of claim 14, wherein causing to be generated or generating said another animated sequence includes causing to be generated or generating said character representation for each letter present in said selectable word in a third cell that is aligned with said first cell along one of said rows or along one of said columns.

17. The method for teaching pronunciation of claim 14, wherein causing to be generated or generating said another animated sequence includes causing to be generated or generating a sentence associated with said selectable word in a fourth cell that is aligned with said first cell along one of said rows or along one of said columns.

18. The method for teaching pronunciation of claim 17, wherein causing to be generated or generating said another animated sequence includes causing to be generated or generating an illustration associated with or depicting the subject matter described in said sentence in a fifth cell that is aligned with said second cell along one of said rows or along one of said columns.

19. A method for teaching pronunciation, said method comprising:
causing to be displayed or displaying at a client device a visual representation of at least one selectable word and/or an illustration of an object associated with said selectable word, and wherein said selectable word includes one or more letters;
receiving an instruction that said selectable word has been selected by a user;
causing to be generated or generating at said client device, in response to selection of said user in said receiving, an animated sequence that includes providing: (i) a character representation of at least some letters of said selectable word and/or textual representation of at least some other letters of said selectable word, wherein a combination of said character representation of said some letters and/or said textual representation of said some other letters conveys said selectable word; (ii) said character representation of said some other letters exhibit anthropomorphic behavior or a changing state of said character representation teaches a pronunciation rule; and (iii) a pronunciation of said selectable word.

20. The method for teaching pronunciation of claim 19, wherein said teaching said pronunciation rule is at least one technique chosen from a group comprising: (i) teaching pronunciation of a combination of letters that produce a single sound when said selectable word is pronounced; (ii) teaching pronunciation of a selectable word that includes one more silent letters; and (iii) teaching pronunciation of said selectable word that is a sight word.

21. The method for teaching pronunciation of claim 19, wherein in said causing to be generated or said generating said animated sequence, said audible and/or said visual representation associated with each said character representation further includes: (i) depicting each of said character representations being spread out from each other by a certain distance; (ii) providing a phonetic pronunciation for each said letter associated with said character representation, as said character representations remain spread out by said certain distance; (iii) depicting each of said character representations as no longer being spread out by said certain distance; and (iv) pronouncing said selectable word.

22. The method for teaching pronunciation of claim 19, wherein said causing to be generated or generating said animated sequence includes presenting, at said client device, a grid that includes one or more rows and one or more columns and an intersection of one of said rows with one of said column defines a cell, which is configured to receive said selectable word or said illustration of an object associated with said selectable word; and wherein said visual representation of said selectable word is arranged inside a first cell and said visual representation of said object associated with said selectable word is arranged inside said second cell, and wherein said first cell and said second cell are aligned along one of said rows or along one of said columns.

23. The method for teaching pronunciation of claim 19, wherein said causing to be generated or generating said another animated sequence includes causing to be generated or generating said character representation for each letter present in said selectable word in a third cell that is aligned with said first cell along one of said rows or along one of said columns.
